(19) United States
(12) Patent Application Publication
(10) Pub. No.: US 2014/0101068 A1
(43) Pub. Date: Apr. 10, 2014

(54) FACILITY-BASED LEARNING MANAGEMENT SYSTEM

(71) Applicant: Learnbeyond, Inc., South Plainfield, NJ (US)

(72) Inventors: Soma Gidugu, Edison, NJ (US); Bhasker R. Nayini, Parsippany, NJ (US)

(73) Assignee: Learnbeyond, Inc., South Plainfield, NJ (US)

(21) Appl. No.: 14/046,146

(22) Filed: Oct. 4, 2013

Related U.S. Application Data
(60) Provisional application No. 61/709,625, filed on Oct. 4, 2012.

(51) Int. Cl. G06Q 50/20; G06Q 10/00

(52) U.S. Cl. CPC G06Q 50/205; G06Q 10/00
USPC 705/327

(57) ABSTRACT

Systems and methods may provide for receiving registration input for a student associated with a first facility, and registering the student in an online course associated with a second facility based on the registration input. In one example, an online presence of the student may be measured, wherein a report can be generated based on the online presence.

### CROSS-REFERENCE TO RELATED APPLICATIONS

The present application claims the benefit of priority to U.S. Provisional Patent Application No. 61/709,625, filed on October 4, 2012.

### BACKGROUND

Embodiments of the present invention generally relate to e-learning. More specifically, embodiments relate to a system that delivers online learning to distributed learners.

Traditional brick and mortar schools may face a number of challenges with regard to meeting the varying needs of different students. For example, if a K-12 (kindergarten through twelfth grade) student is in need of a course that is either significantly behind or ahead of the student's current grade level, the course may not be offered at the school in which the student is enrolled. Indeed, registering the student in such a course and delivering the course to the student may require complex communications between administrative personnel, instructors, parents and the student and/or physical travel on the part of the student. While certain online educational solutions may exist at the collegiate and professional levels, those solutions may fail to address the unique nature of classroom and/or grade based learning, particularly in a cross facility context. For example, conventional online educational solutions may fail to adequately track the student's activity with regard to the course because they are tailored to adults and professionals who may not be accustomed to high levels of monitoring.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a classroom based and classroomless registration scheme according to an embodiment;

FIG. 2 is a block diagram of an example of a cross facility registration scheme according to an embodiment;

FIG. 3 is a block diagram of an example of an online presence measurement scheme according to an embodiment;

FIG. 4 is a block diagram of an example of a system architecture according to an embodiment;

FIG. 5 is an architectural block diagram of an example of a classroom based system according to an embodiment;

FIG. 6 is a screen shot of an example of a user profile interface upon login according to an embodiment;

FIG. 7 is a screen shot of an example of an organizer interface according to an embodiment;

FIG. 8 is a screen shot of an example of an announcements interface according to an embodiment;

FIG. 9 is a screen shot of an example of a document management interface according to an embodiment;

FIG. 10 is a screen shot of an example of a course creation interface according to an embodiment;

FIG. 11 is a screen shot of an example of a list of available courses according to an embodiment

FIG. 12 is a screen shot of an example of a student grading and reporting interface according to an embodiment;

FIG. 13 is a screen shot of an example of a reporting home page according to an embodiment;

FIG. 14 is a screen shot of an example of an internal mail system interface according to an embodiment;

FIG. 15 is a screen shot of an example of a discussion forum interface according to an embodiment;

FIG. 16 is a screen shot of an example of an e-classroom according to an embodiment;

FIG. 17 is a screen shot of an example of a list of meetings, virtual classes and other scheduled classes according to an embodiment;

FIG. 18 is a screen shot of an example of a student home page according to an embodiment;

FIG. 19 is a screen shot of an example of a user search interface according to an embodiment;

FIG. 20 is a screen shot of an example of a student dashboard according to an embodiment;

FIG. 21 is a screen shot of an example of a list of assignments according to an embodiment;

FIG. 22 is a screen shot of an example of a student assessment report according to an embodiment;

FIG. 23 is a screen shot of an example of an online presence report according to an embodiment;

FIG. 24 is an illustration of an example of a class management sequence according to an embodiment;

FIG. 25 is an illustration of an example of a class modification sequence according to an embodiment;

FIG. 26 is an illustration of an example of a section creation sequence according to an embodiment;

FIG. 27 is an illustration of an example of a section deletion sequence according to an embodiment;

FIG. 28 is an illustration of an example of a student addition sequence according to an embodiment;

FIG. 29 is an illustration of example of a student editing sequence according to an embodiment;

FIG. 30 is an illustration of an example of a student deletion sequence according to an embodiment;

FIG. 31 is an illustration of an example of a teacher deletion sequence according to an embodiment;

FIG. 32 is an illustration of an example of an assessment import sequence according to an embodiment;

FIG. 33 is a screen shot of an example of a list of assessment items according to an embodiment;

FIG. 34 is a screen shot of an example of an assessment according to an embodiment;

FIG. 35 shows a method of operating a learning management system according to an embodiment; and

FIGS. 36 to 45 show example block diagrams and screen shots of a course builder according to embodiments.

### DETAILED DESCRIPTION

Embodiments may include a computer readable storage medium having a set of instructions which, if executed by a processor, cause a computer to receive registration input for a student associated with a first facility. Additionally, if executed, the instructions may cause a computer to enroll the student in an online course associated with a second facility based on the enrollment input.

Additionally, embodiments may include an apparatus having an administration logic module to receive registration input for a student associated with a first facility. The apparatus may also include a core logic module to register the student in an online course associated with a second facility based on the registration input.

Embodiments may also include a computer implemented method in which registration input is received for a student associated with a first facility, wherein the registration input includes a K-12 grade level identifier. The method can also provide for enrolling the student in an online course associated with a second facility based on the registration input, wherein the online course is a classroomless course. Moreover, an online presence of the student may be measured with respect to one or more of the course and a set of login sessions. The method may also involve generating a report based on the online presence, wherein the report quantifies one or more of a course material usage, an assessment usage, an assignment usage, an e-classroom usage, and a chat usage by the student.

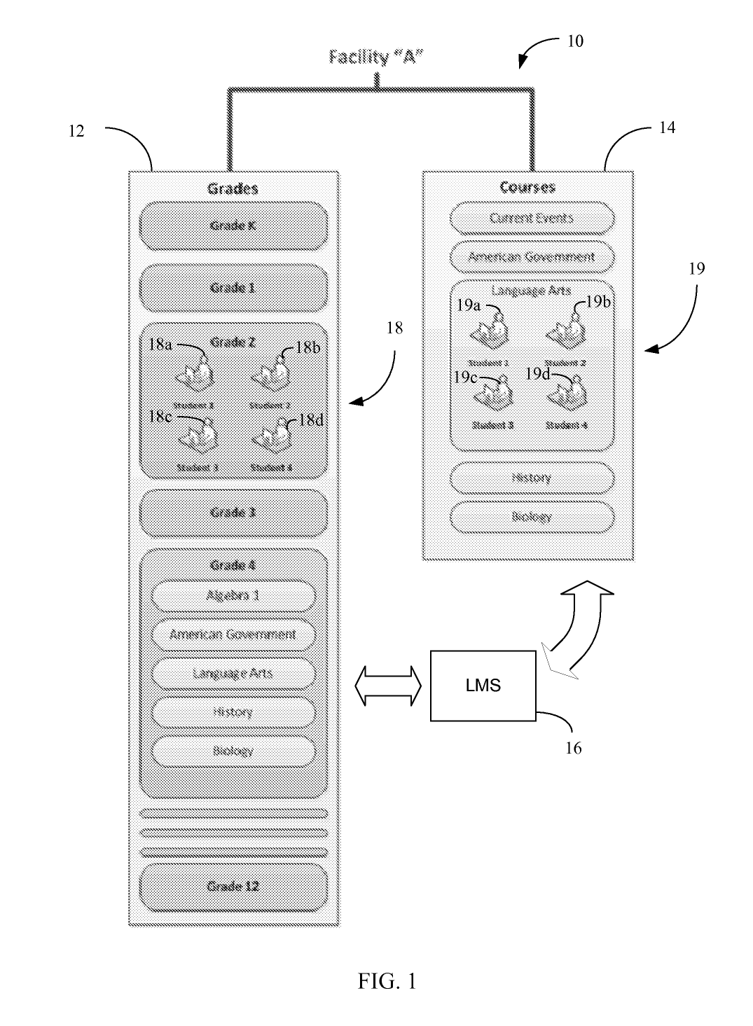

Turning now to FIG. 1, a facility (“Facility ‘A’”) 10 is shown in which both classroom based learning and course based (e.g., “classroomless”) learning are supported. In the illustrated example, students such as students 18 (18a-18d) are organized into traditional K-12 grade levels 12, whereas students such as students 19 (19a-19d) are organized into one or more of a variety of courses 14 also offered by the facility 10. As will be discussed in greater detail, a learning management system (LMS) 16 may be used to deliver complete, e-learning (electronic learning) capabilities with integrated, state of the art tools, resulting in a new standard of e-learning. More particularly, the system 16 can enable teachers to deliver and manage courses and assessments to both the classroom based students 18 and the classroomless students 19 (e.g., anywhere, anytime).

In addition, the system 16 may be accompanied by a suite of collaboration tools (e.g., modules) that facilitate learning in future generations. For example, the system 16 may include numerous features such as an easy-to-access course material interface, an informative reporting system, student-to-student and student-to-teacher communication tools, an e-classroom, assessment reminders and more. Additionally, the system 16 can enable parents to monitor their children's performance on assignments and assessments. Indeed, parents can also obtain a complete analysis of the time spent by their children in various activities such as reading materials, assessments, e-classroom, and chat sessions with other students and teachers.

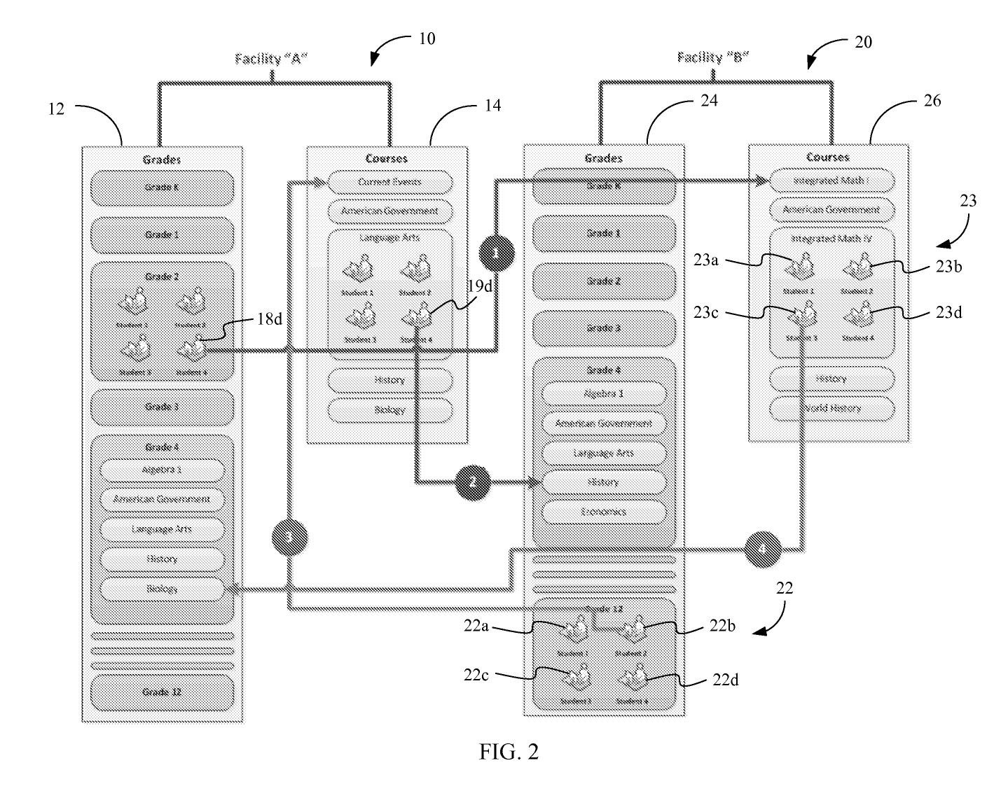

FIG. 2 shows a cross facility registration scheme in which students may register for and take courses offered by different facilities. The cross facility registration scheme may also include another facility (“Facility ‘B’”) 20 having classroom based students 22 (22a-22d) organized into K-12 grade levels and classroomless students 23 (23-23d) organized into one or more courses 26 offered by the facility 20. The other facility 20 might be located, for example, in a different zone, school district, county, state, nation, etc., than the facility 10. For example, the facilities 10, 20 could have different instructors, resources, areas of emphasis, capabilities, etc., that result in different course offerings being available in both the classroom based context and the classroomless context.

In the illustrated example, a classroom based student 18d enrolled in the second grade at the facility 10 registers for and takes a classroomless math offering (“Integrated Math I”) of the other facility 20, while a classroomless student 19d associated with the facility 10 registers for and take a fourth grade classroom based course (“History”) of the facility 20. Additionally, a classroom based student 22b may register for and take a classroomless offering (“Current Events”) of the facility 10, and a classroomless student 23c may register for and take a fourth grade classroom based course (“Biology”) of the facility 10. Of particular note is that the Integrated Math I course offering of the facility 20 is not available at the facility 10, in the example shown. Similarly, the Current Events and fourth grade Biology course offerings of the facility 10 are not available at the facility 20, in the example shown.

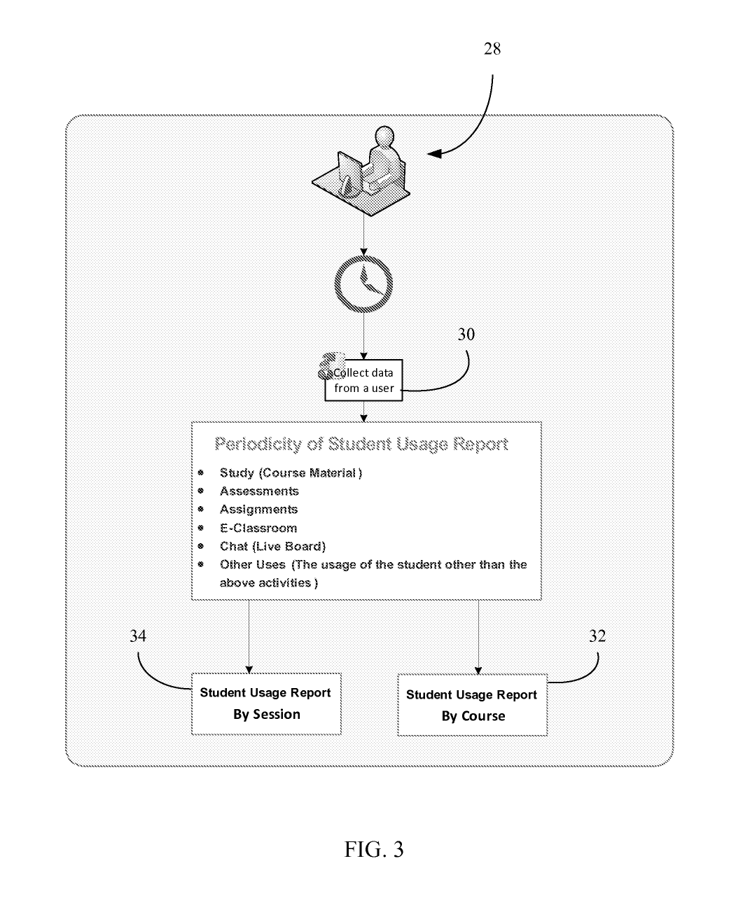

Turning now to FIG. 3, an online presence measurement scheme is shown. In the illustrated example, a student 28 participates in a course, wherein data 30 associated with such participation is collected and used to determine the extent to which the student 28 has participated in the course. More particularly, the student's periodicity of usage can be quantified with respect to course material usage, assessment usage, assignment usage, e-classroom usage, chat usage, and forth. Additionally, reports such as a course specific report 32 and a session specific report 34 may be generated based on the measured online presence of the student 28. Of particular note is that the high level of detail available in the reports 32, 34 may represent a significant improvement over conventional online learning solutions.

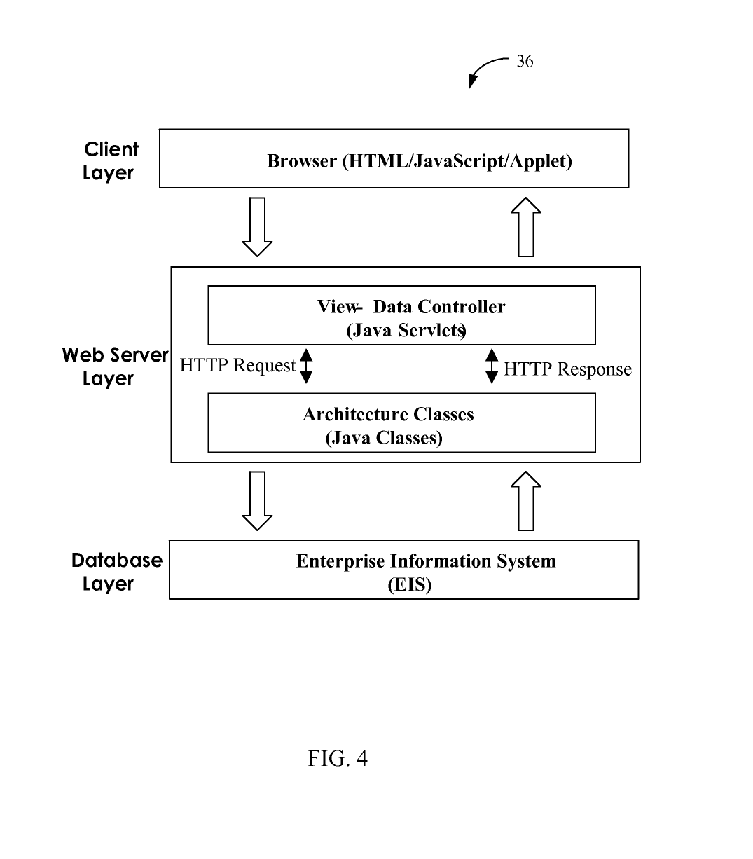

FIG. 4 shows a system architecture 36 in which a client layer serves HTML/JavaScript pages and java applets on the end user's machine via a browser (e.g., Internet Explorer 6 through 8). A web server layer can serve static web pages and servlets via a data controller and architecture classes, wherein a view-Data Controller may be responsible for generating dynamic HTML/JavaScript pages or redirecting HTML/JavaScript pages to the browser. Additionally, one or more architecture classes provide the necessary framework for database connection pooling, error logging and server startup work, in the example shown. Moreover, a database layer may include a relational database such as MySQL Server. The architecture 36 may be used to implement a learning management system such as, for example, the system 16 (FIG. 1).

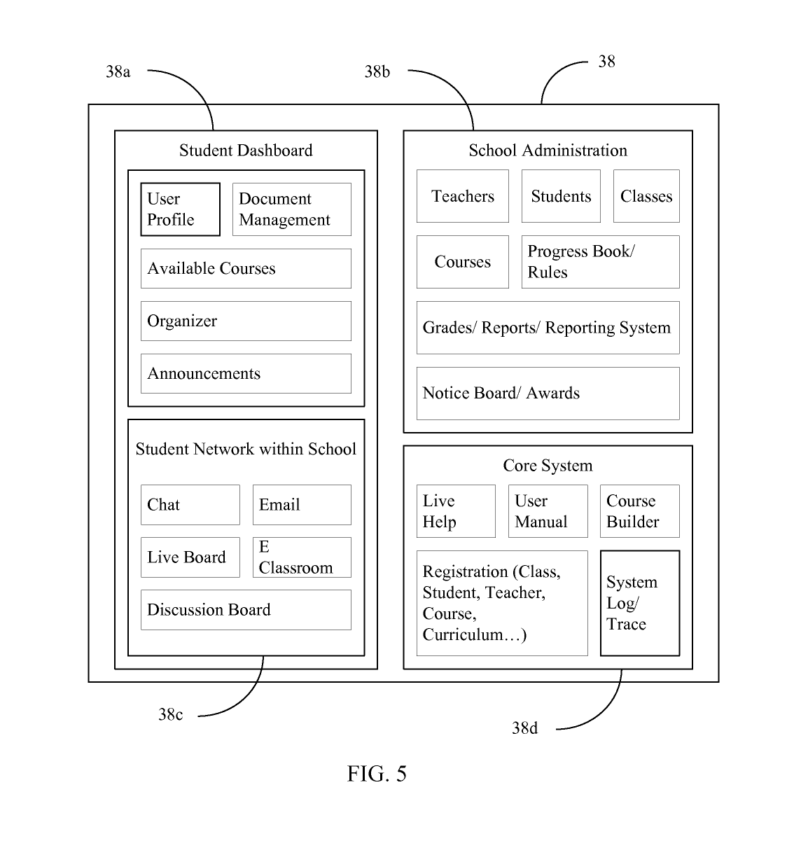

FIG. 5 shows a logic architecture 38 (38a-38d) that may be used to implement a user interface for a learning management system such as the system 16 (FIG. 1). In general, the logic architecture 38 may include a dashboard logic module 38a, an administration logic module 38b, a student network logic module 38c and a core logic module 38d.

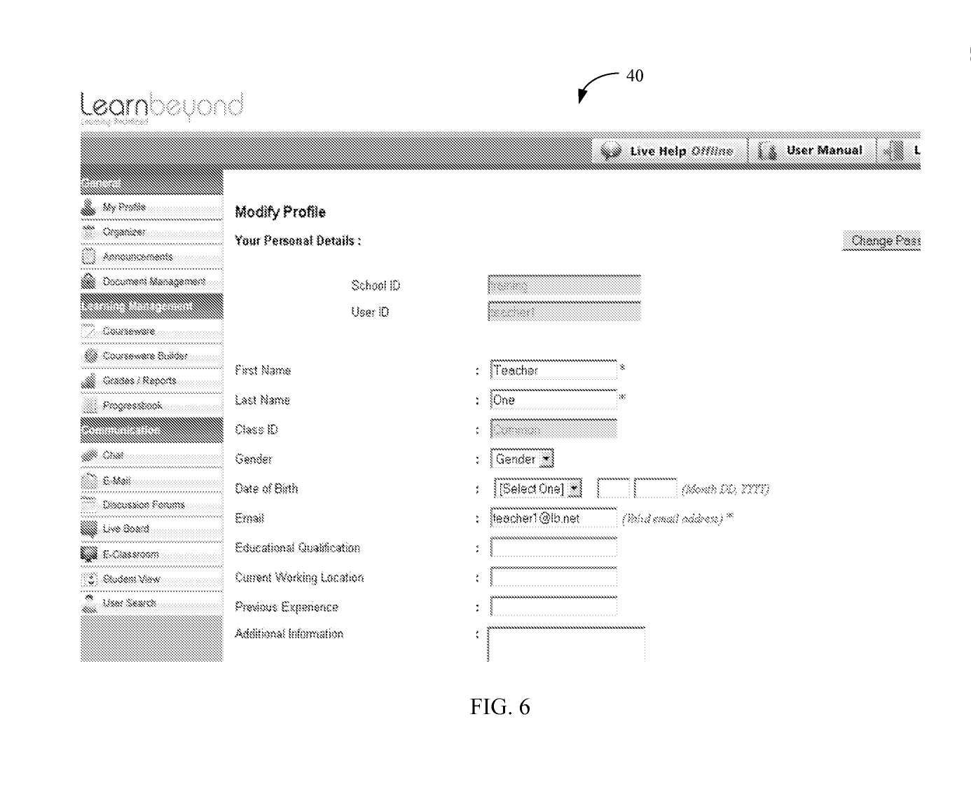

FIG. 6 shows a user profile interface 40 that includes a School ID, Class ID and User ID in the textboxes that cannot be edited. The rest of the additional general information can be edited and updated, in the example shown. The interface 40 may also provide an option to change passwords, wherein some fields in the interface 40 may be defined as mandatory. For example, the student may be required to provide his/her first name, last name and email address. The user profile interface 40 may be implemented in a student dashboard such as, for example, the dashboard logic module 38a (FIG. 5), already discussed.

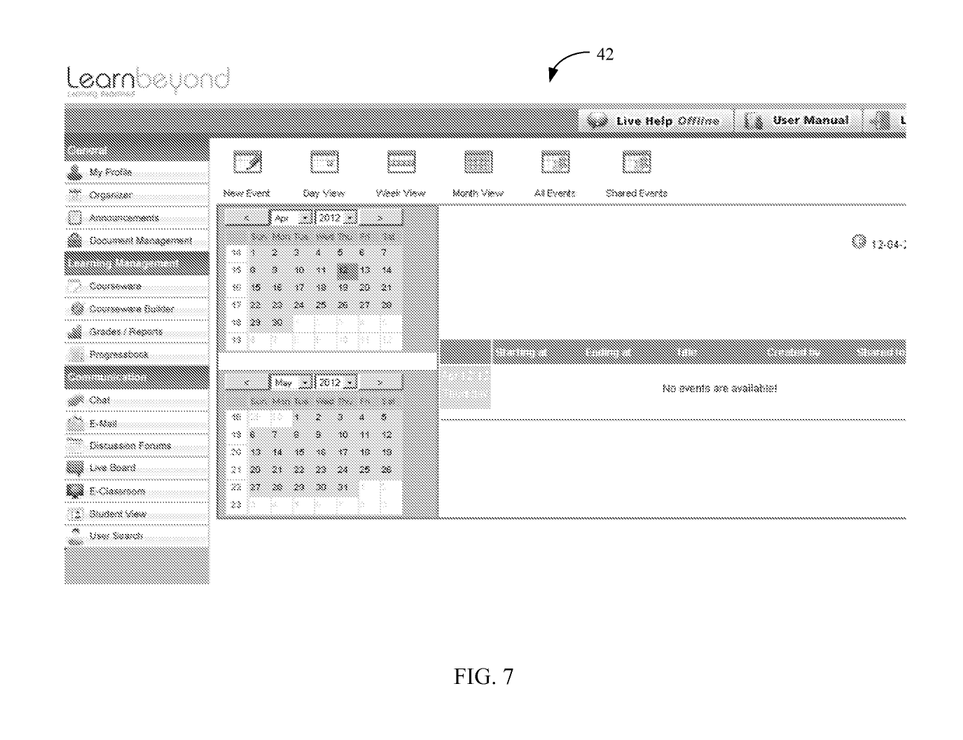

FIG. 7 shows an organizer interface 42 that includes a calendar view having the current date and events for current day, week and month highlighted. The interface 42 may show information about the events coming up in the current month and next month. Additionally, there may be a provision to create a new event, wherein the interface 42 can be viewed in different ways. For example, the user can view the organizer page in Day view, week view, and month view or else can only see all events. Moreover, when an event is created, the day may be highlighted in the calendar, wherein the event is also shown in the dashboard. The interface 42 can also provide information about whether this is a shared event or a personal event. In addition, an event highlighter may be used to remind the user about event upon login. The organizer interface 42 may be implemented in a student dashboard such as, for example, the dashboard logic module 38a (FIG. 5), already discussed.

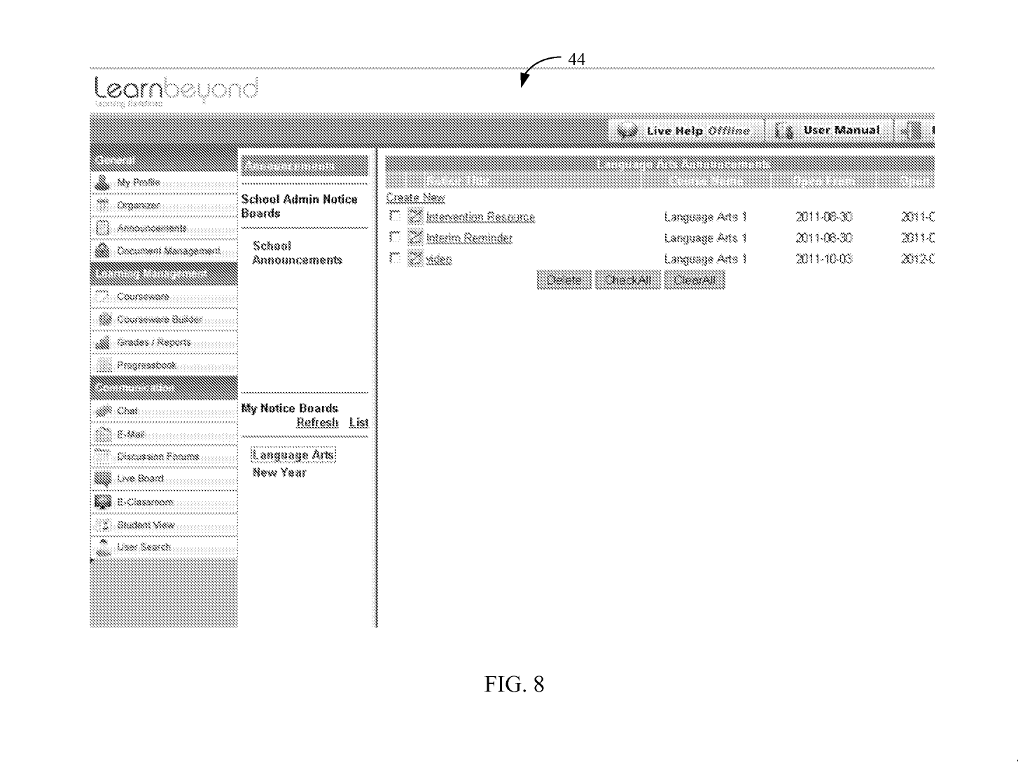

FIG. 8 shows an announcement interface 44 that provides information about announcements that take place in school (i.e., “school announcements”). In the illustrated example, the interface 44 provides information to be displayed on notice boards and primarily carries information to be circulated to students and staff, etc. The interface 44 may provide additional information about student reports, awards won, highlighted activities, and so forth. The interface 44 may also support subject based notice categorization. The announcement interface 44 may be implemented in a student dashboard such as, for example, the dashboard logic module 38a (FIG. 5), already discussed.

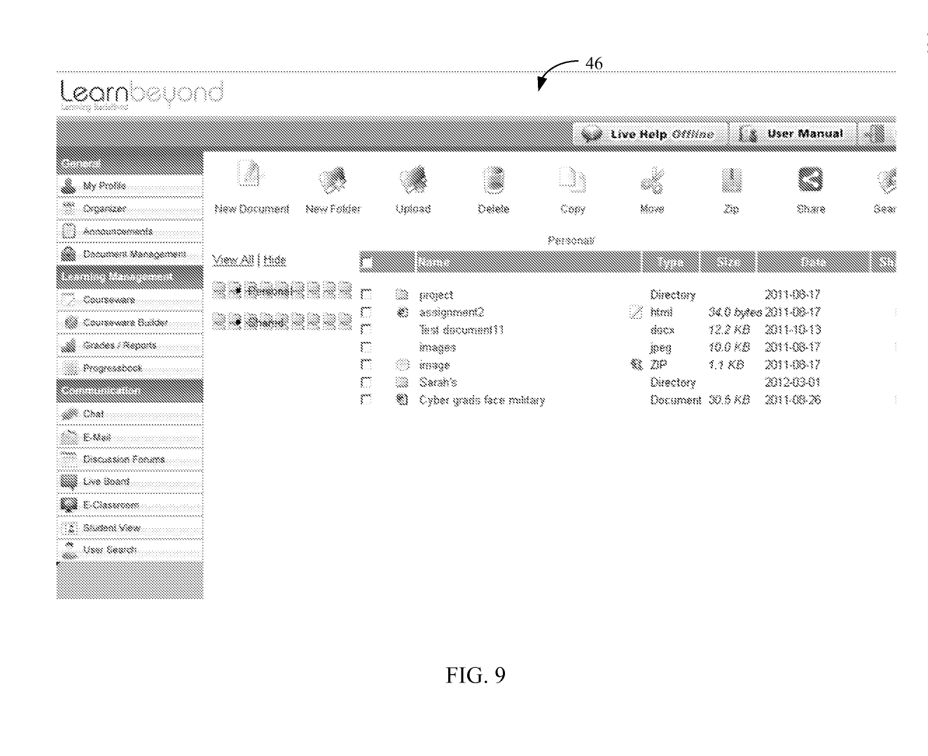

FIG. 9 shows a document management interface 46 that enables user to add documents, create folders, delete folders, etc. Thus, interface 46 may deal with documents, termed as a “document library”, wherein the complete structure of files and folders may be shown. The illustrated interface 46 provides the option to create documents, folders, and upload documents. Indeed, all the available files and folders can be seen in the illustrated example, along with the type, size and the updated date/time, all in the same window. Moreover, regular file operations can be made available for the user. These features may include, for example, copy, move, delete, share and search. If the size of the documents is large, user may also be provided the ability to zip them in the environment. User can also upload multiple files/documents in a single step with the help of Upload option available in document management. The document management interface 46 may be implemented in a student dashboard such as, for example, the dashboard logic module 38a (FIG. 5), already discussed.

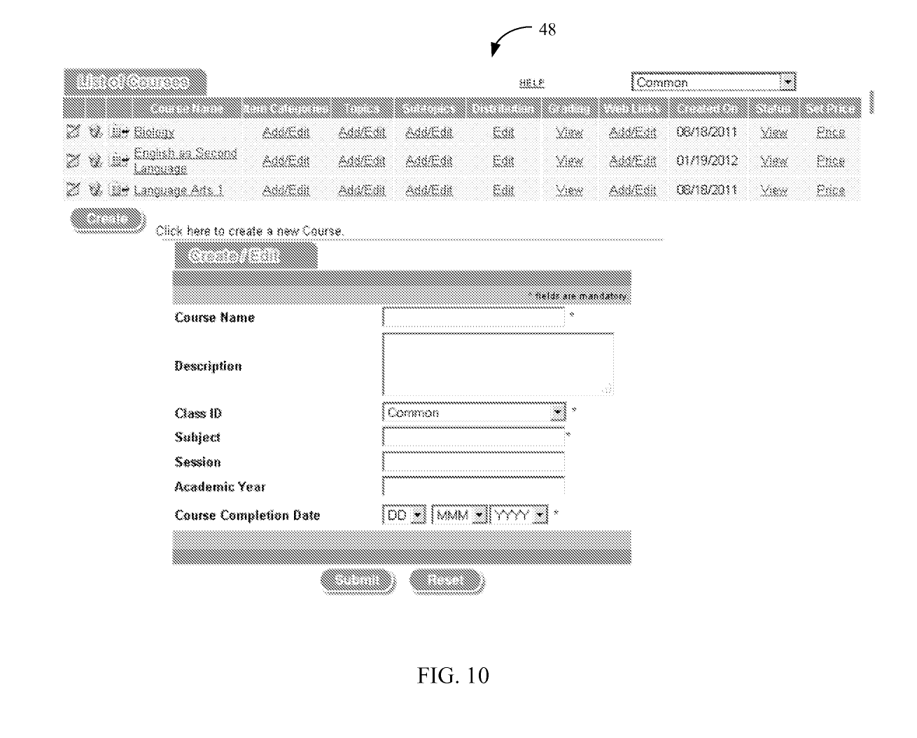

FIG. 10 shows a course creation interface 48 in which a list of available courses taught by a specific teacher is displayed. Thus, teachers are able to create a new course, which may involve providing basic information such as course name, class name, subject, academic year, completion date and description. Additionally, the teacher can edit, delete and define different marking periods for the course, wherein the marking period may indicate the time line defined based on an associated academic curriculum. More particularly, an item category may indicate the type of course/exam such as, for example, assignments, project work, home work (e.g., sub categories depend upon teacher), assessments, exams, self-tests, quiz (e.g., sub categories depend upon teacher), course materials, and so forth. Adding topics and sub topics may also depend upon the specific teacher. The distribution column may indicate to which students this course needs to be distributed, wherein the course can be distributed to all students or some of the students in the class (e.g., as determined by the teacher). The illustrated interface 48 also includes important web links (e.g., references), grading structures and divisions. The course creation interface 48 may be implemented in a school administration module and/or core system such as, for example, the administration logic module 38b and/or core logic module 38d (FIG. 5), already discussed.

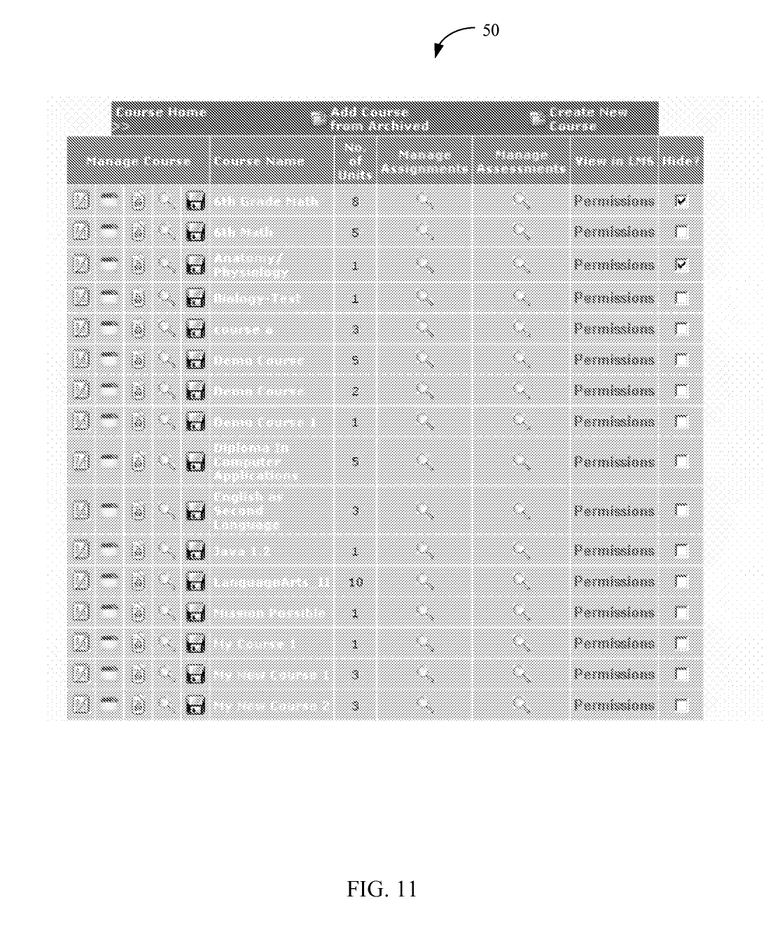

FIG. 11 shows a list 50 of available courses, wherein a teacher may use the list 50 to manage courses among classes and students. In this regard, the system may include a course builder that acts as central repository for all the courses created by teachers. Moreover, all courses may be seen here by any teacher if it is provided with public option. If any course is created as private by a teacher at the time of creation, that course can be seen here by that teacher only. Courses that are public, on the other hand, may be seen by other teachers and distributed by them to students, but they cannot delete, update or modify any of the course contents, in the example shown. The illustrated list 50 may also facilitate the management of assessments and assignments, by providing options to create, edit and delete the assessments and assignments. Even though the user may view the course, any given course may still be hidden by checking the option towards the right side of the interface. This option may be particularly useful when the teacher who has created wishes to edit/update the course material created.

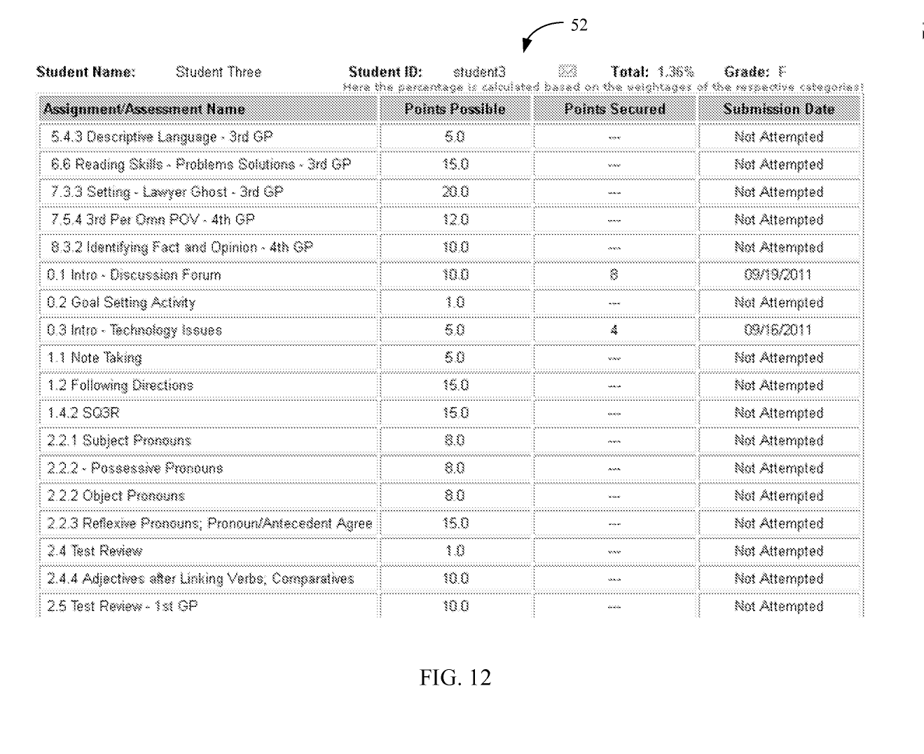

FIG. 12 shows a student grading and reporting interface 52 in which the student's performance on assignments and/or assessments of a course may be viewed in a single window. In the illustrated example, a total percentage is calculated based on weights of the respective categories.

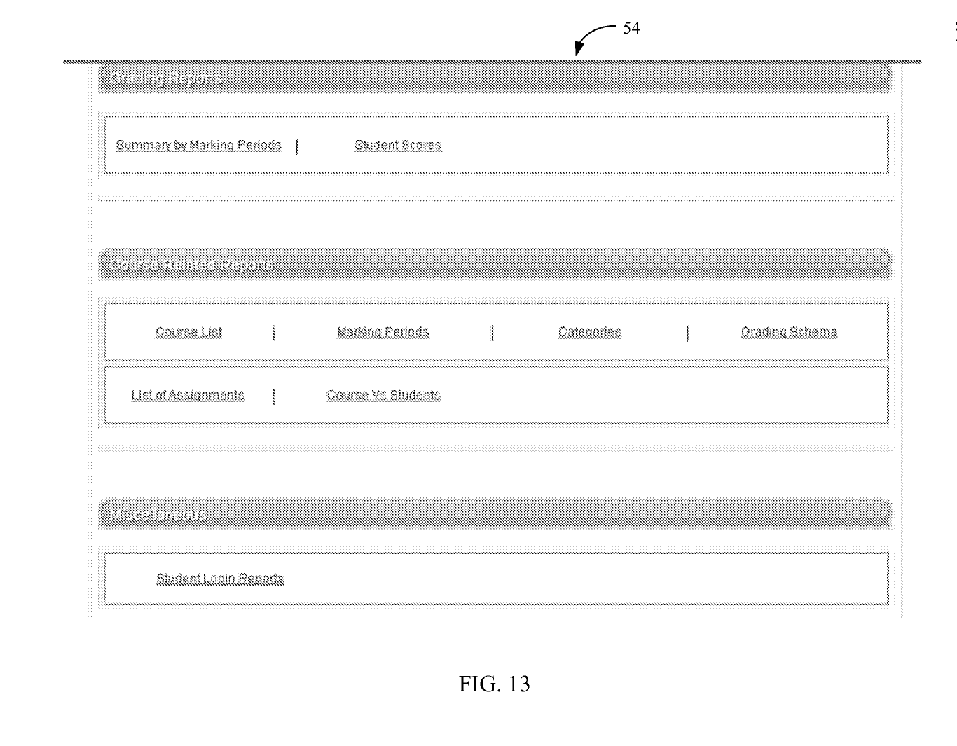

FIG. 13 shows a reporting home page 54 in which various reports based on courses, miscellaneous login reports (e.g., student login reports), etc., may be generated. Thus, the student login reports may be used to determine the online presence of a student, as already discussed.

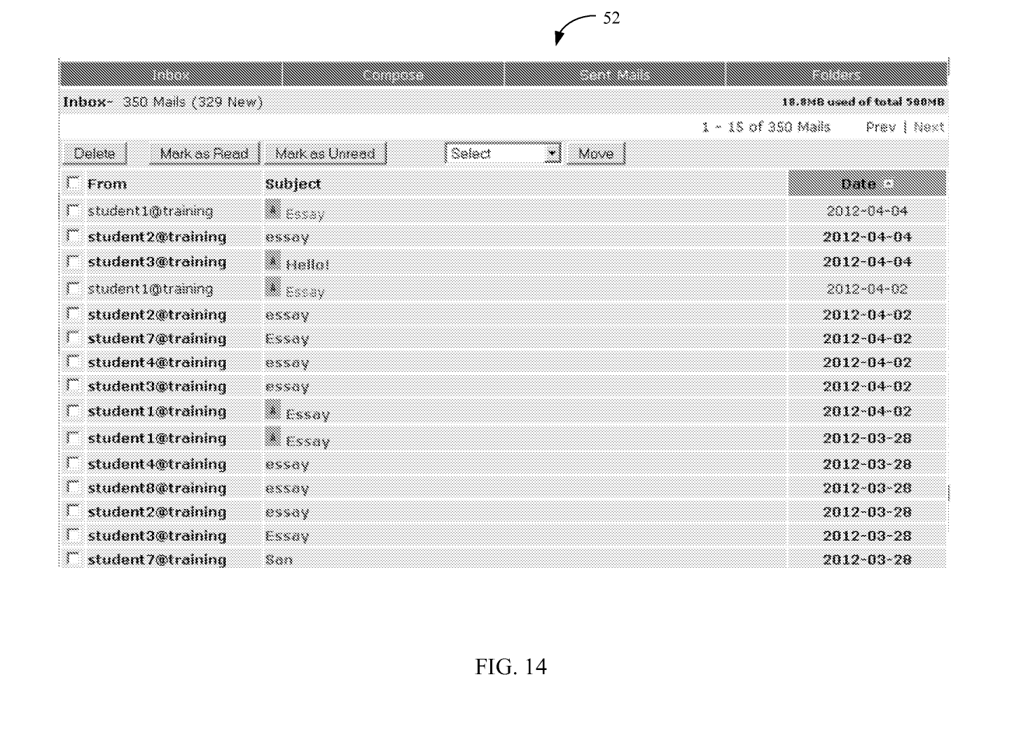

FIG. 14 shows an internal mail system interface 56. In the illustrated example, the user is able to read, delete, mark as read, mark as unread, sort, etc., internal messages.

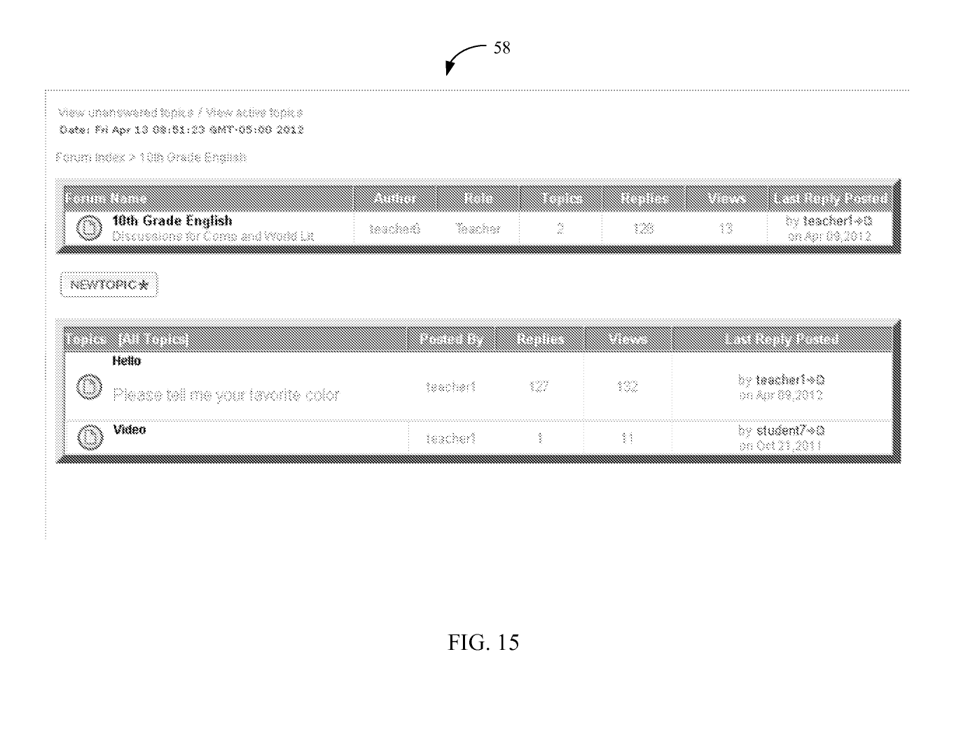

FIG. 15 shows a discussion forum interface 58. In the illustrated example, teachers and students may participate in online discussions regarding courses and/or assignments.

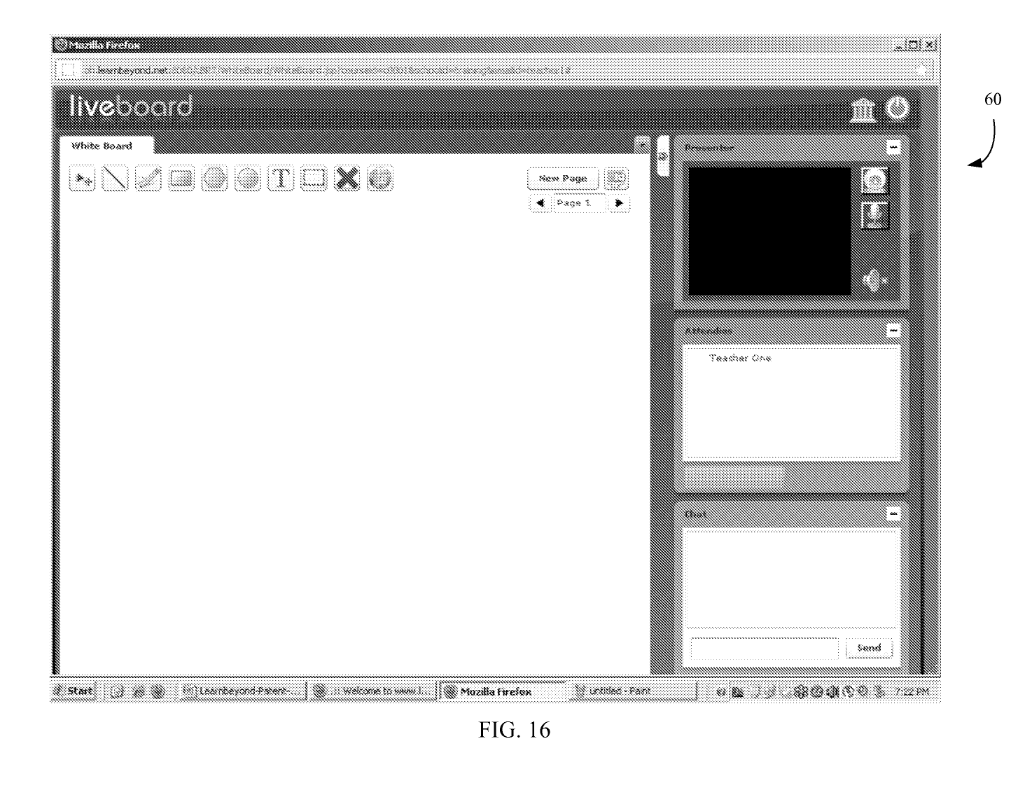

FIG. 16 shows an e-classroom 60. In the illustrated example, the e-classroom includes a live board as well as options to chat and write on the live board.

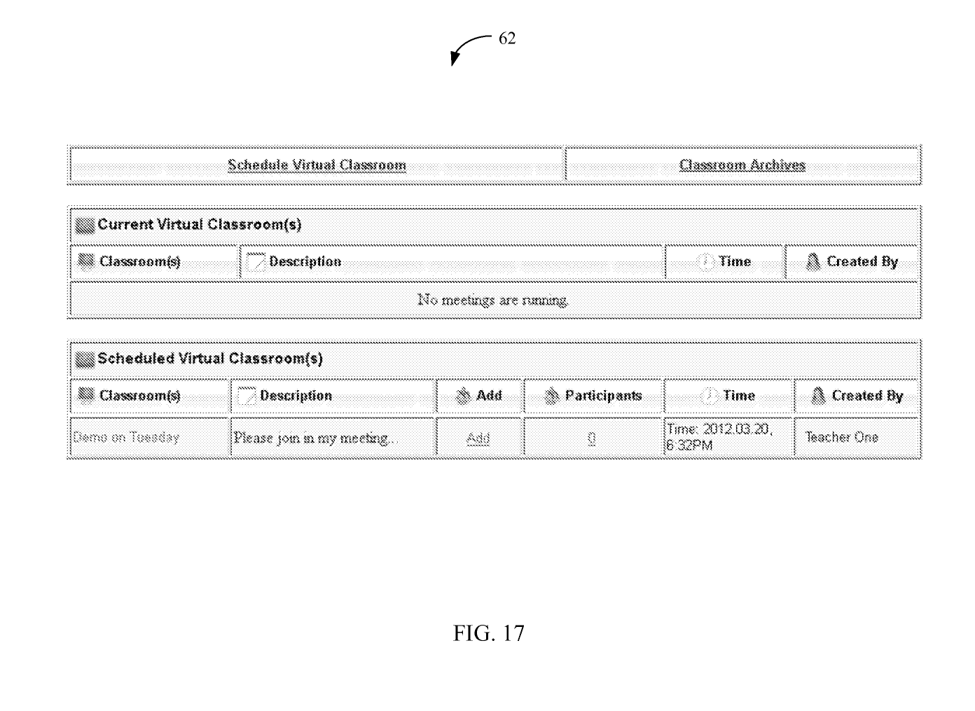

FIG. 17 shows a list 62 of meetings, virtual classes and other scheduled classes. In the illustrated example, the user is notified of current virtual classrooms as well as scheduled virtual classrooms.

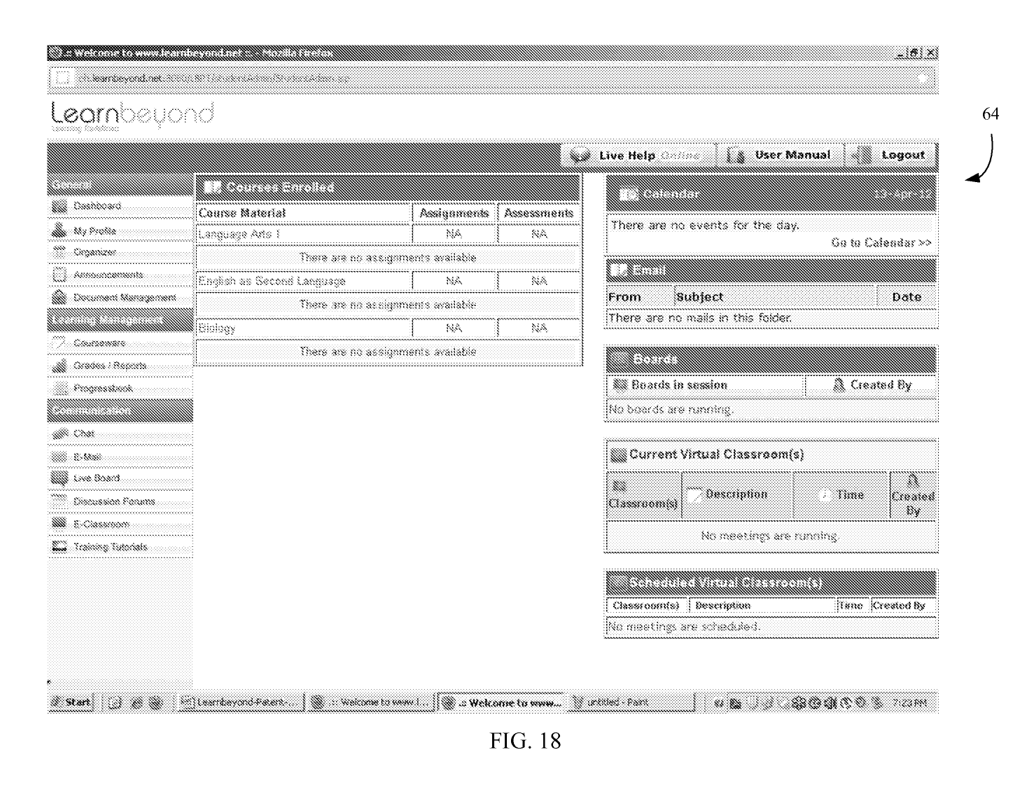

FIG. 18 shows a student home page 64. In the illustrated example, the user is provided with options/links to navigate to different pages within the website. For example, a menu list with major categories such as “General”, “Learning Management” and “Communication” may be displayed, wherein the General sub menu items might include options such as My Profile, Organizer, Announcements and Document Management. Learning Management sub menu items may include options such as Courseware, Courseware Builder, Grades/ Reports and Progress book. Additionally, Communication sub menu items may include options such as Chat, E-Mail, Discussion Forum, Live Board, E-Classroom, Student View and User Search.

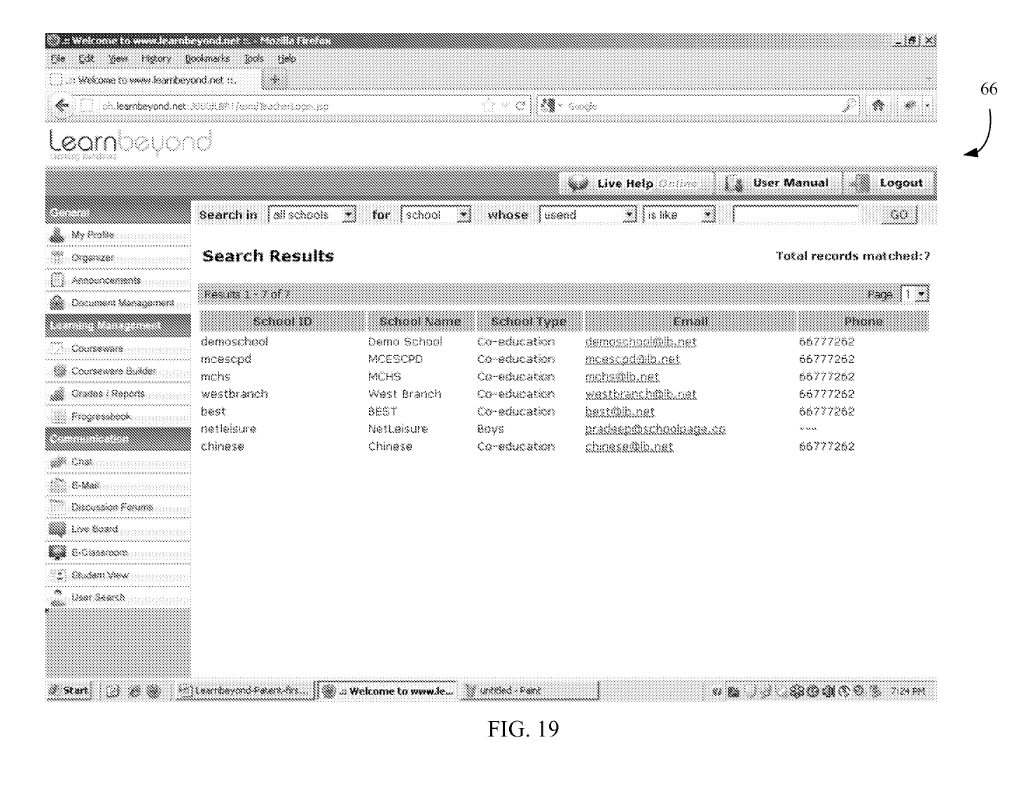

FIG. 19 shows a user search interface 66. In the illustrated example, searches may be filtered based on the facility, keyword, and so forth. The interface 66 may be particularly useful for cross facility registration schemes such as the scheme described with regard to facilities 10, 20 (FIG. 2).

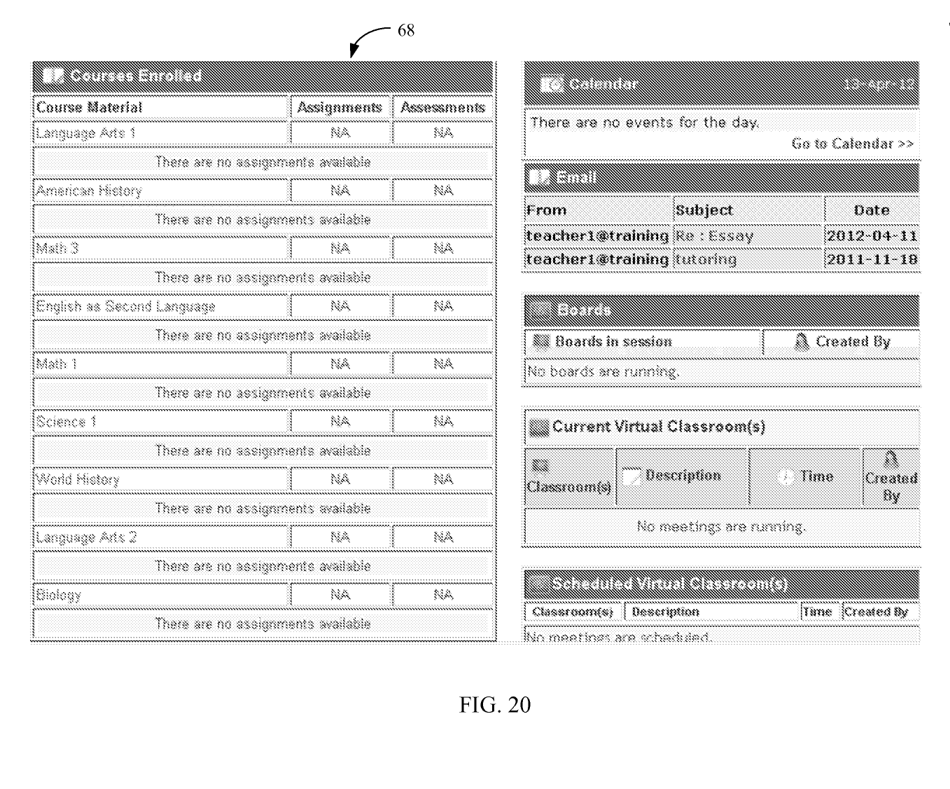

FIG. 20 shows a student dashboard 68. In the illustrated example, the student can view the courses in which the student is enrolled, a calendar, an email preview, any active message boards, current virtual classrooms, scheduled virtual classrooms, and so forth.

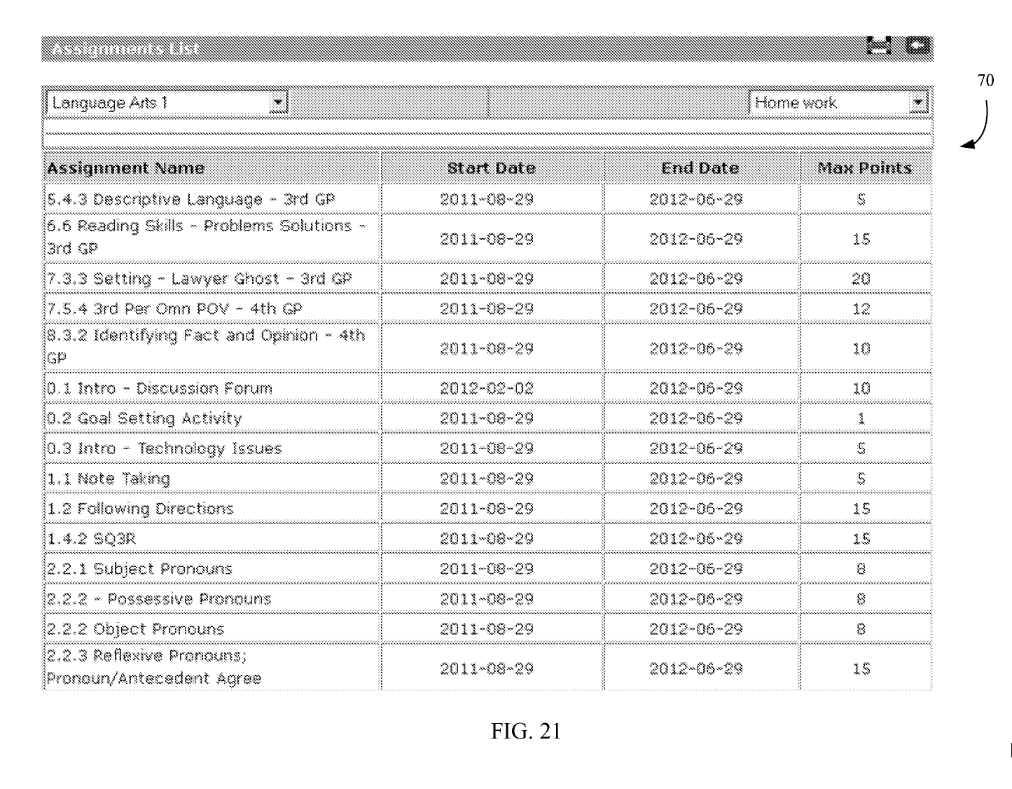

FIG. 21 shows a list 70 of assignments. In the illustrated example, assignments may be filtered on the basis of the specific course and/or type of assignment. Moreover, the assignment name, start date, end date, and maximum number of points may also be displayed.

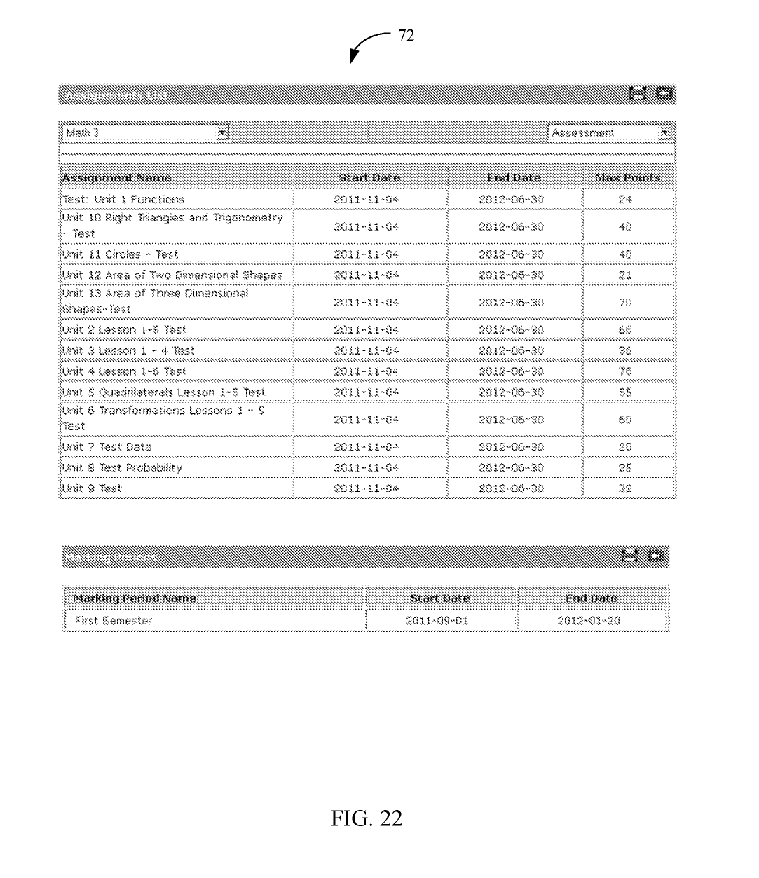

FIG. 22 shows a student assessment report 72. In the illustrated example, the report contains a list of assignments and identifies the marking period associated with the list of assignments.

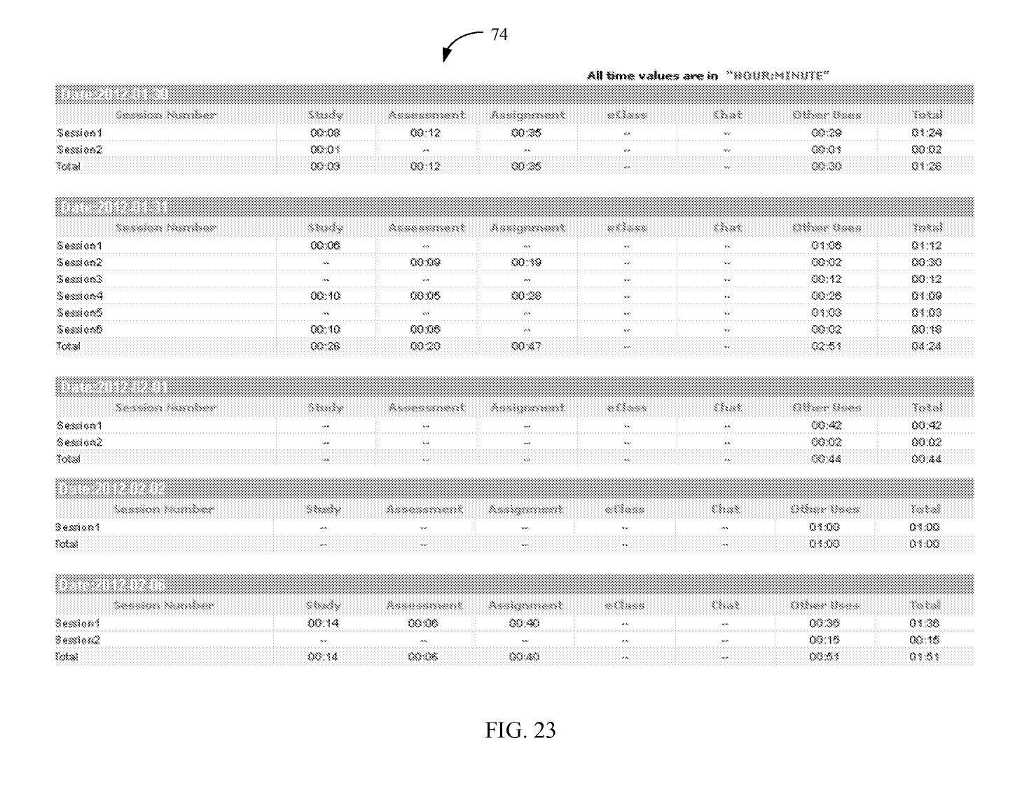

FIG. 23 shows an online presence report 74. In the illustrated example, the report 74 is generated on a session by session basis. The report 74 may also be generated on a course by course basis.

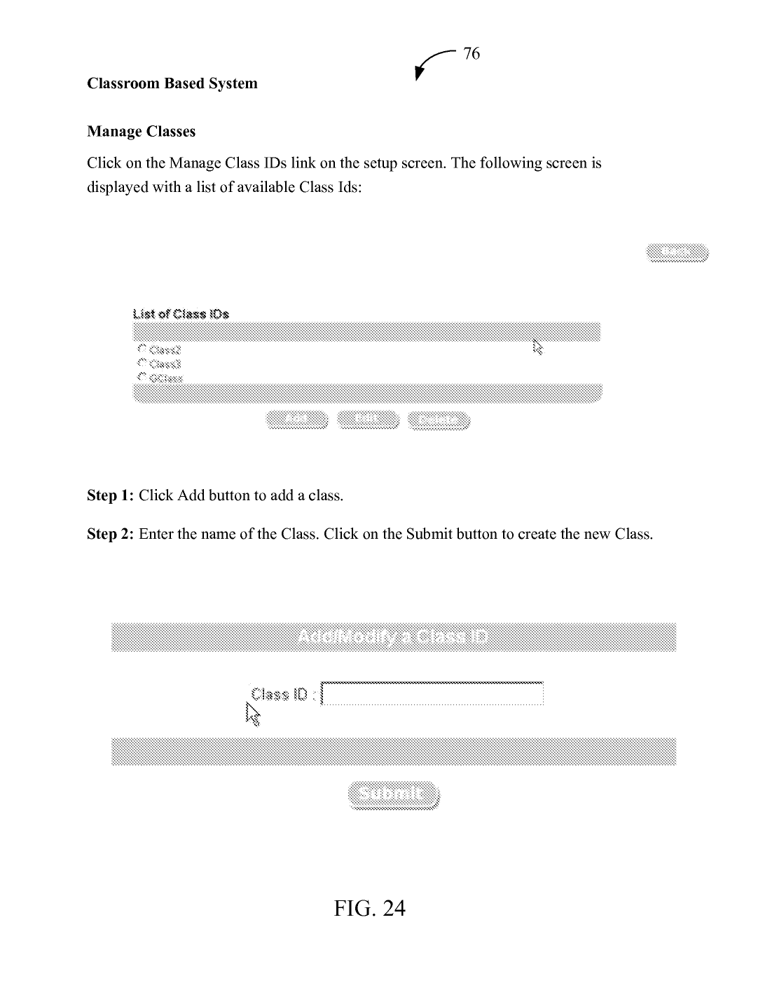

FIG. 24 shows a class management sequence 76. In the illustrated example, the user selects an Add button, enters the name of the course, and selects the submit button.

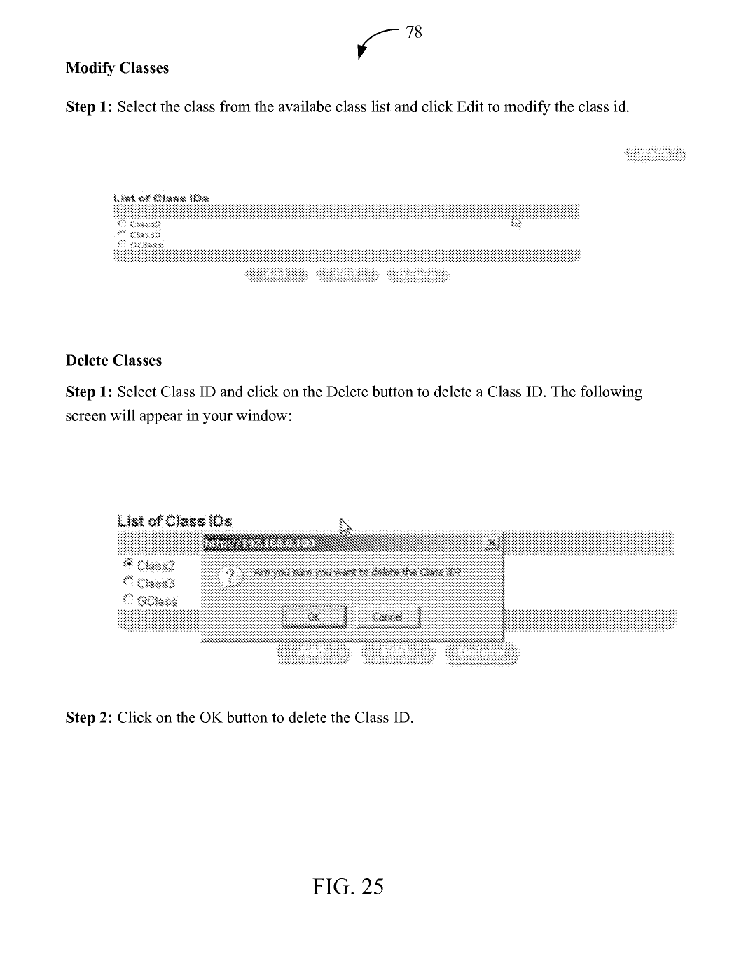

FIG. 25 shows a class modification sequence 78. In the illustrated example, the user selects the course from an available course list and selects an Edit button to modify the course. Additionally, the user may select the course from the available course list and select a Delete button to delete the course, wherein a delete confirmation dialog may be displayed.

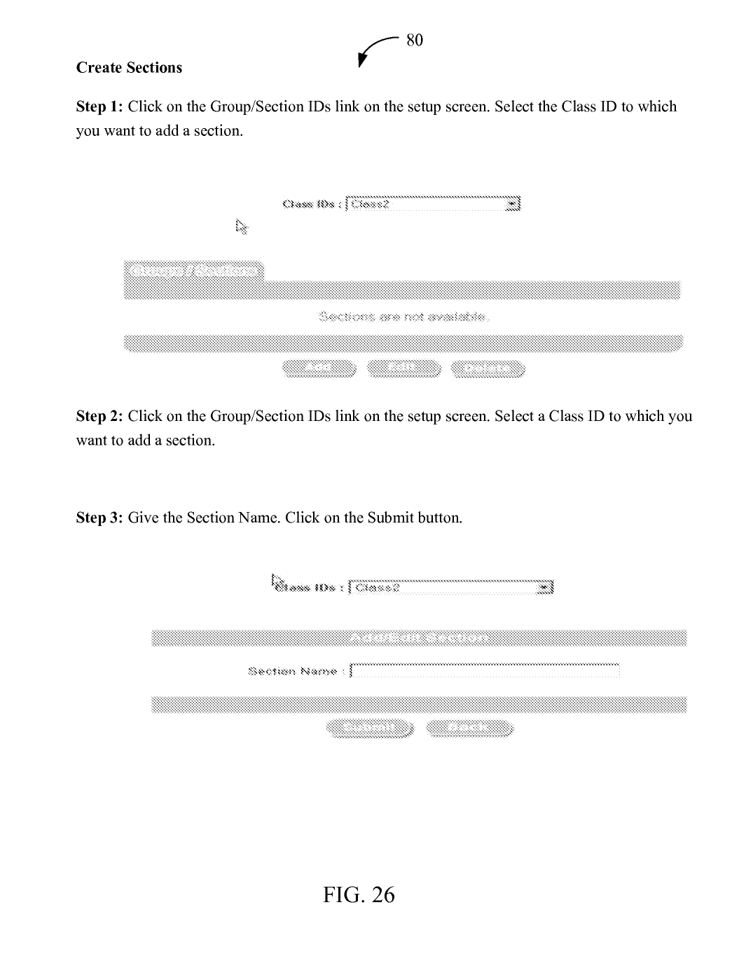

FIG. 26 shows a section creation sequence 80. In the illustrated example, the user may select a group/section ID link from a setup screen, select the course identifier, and enter the section name.

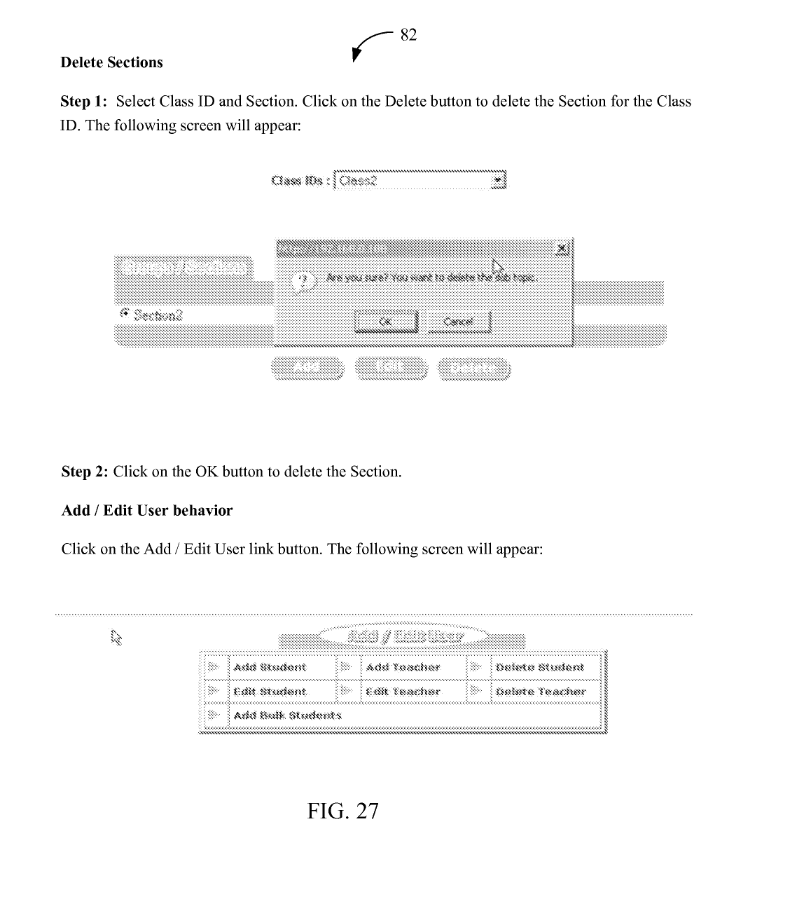

FIG. 27 shows a section deletion sequence 82. In the illustrated example, the user may select a course identifier and section, select a Delete button, and confirm the deletion. The sequence 82 may also provide for adding and/or editing a user such as a student or teacher.

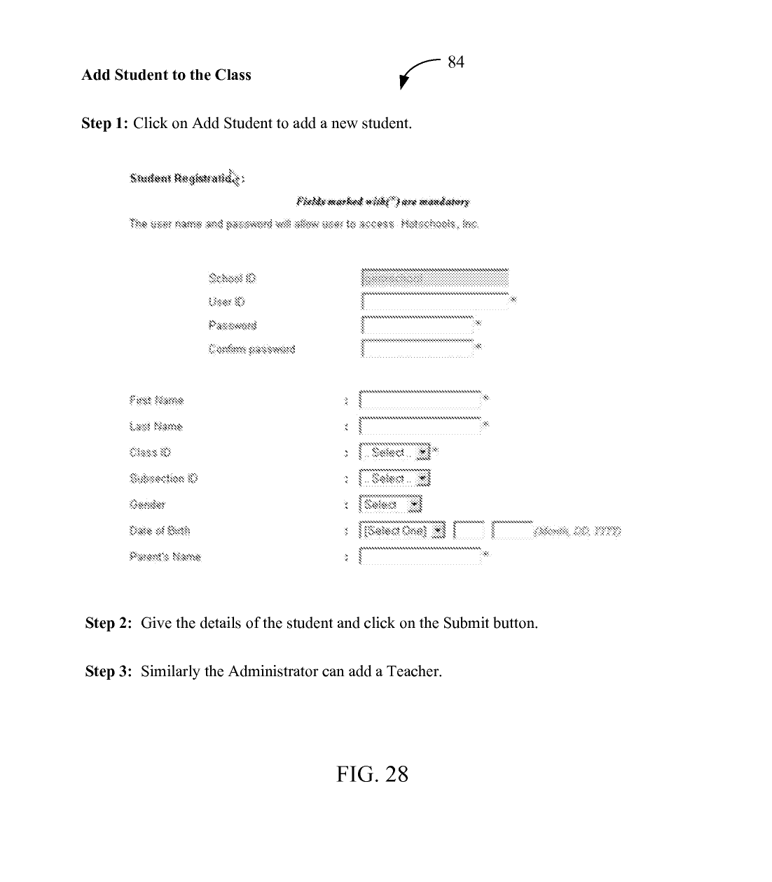

FIG. 28 shows a student addition sequence 84. In the illustrated example, the user may select an Add option and enter the details of the student. Additionally, the sequence 84 may be used to add a teacher to a course.

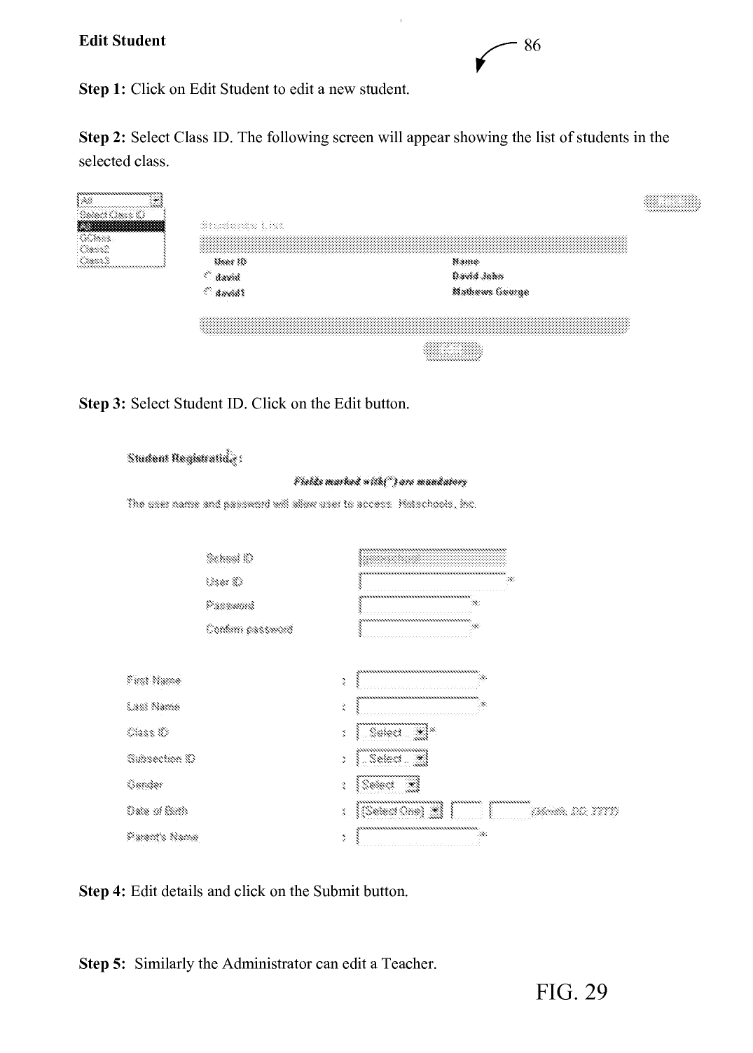

FIG. 29 shows a student editing sequence 86. In the illustrated example, the user may select a course identifier, select a student identifier, and enter the details of the student. Additionally, the sequence 86 may be used to edit a teacher of a course.

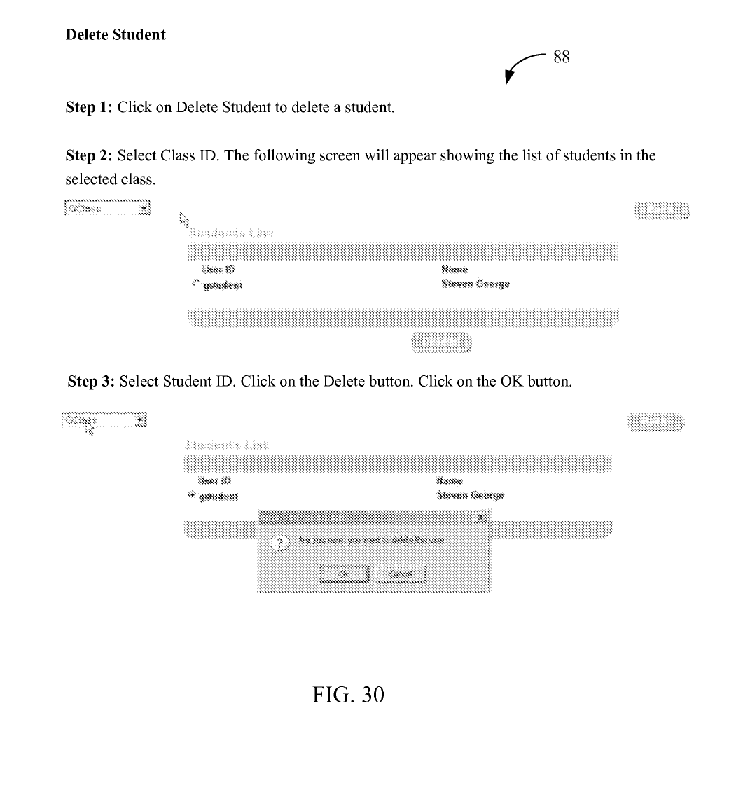

FIG. 30 shows a student deletion sequence 88. In the illustrated example, the user may select a course identifier, select a student identifier, select a Delete button and confirm the deletion.

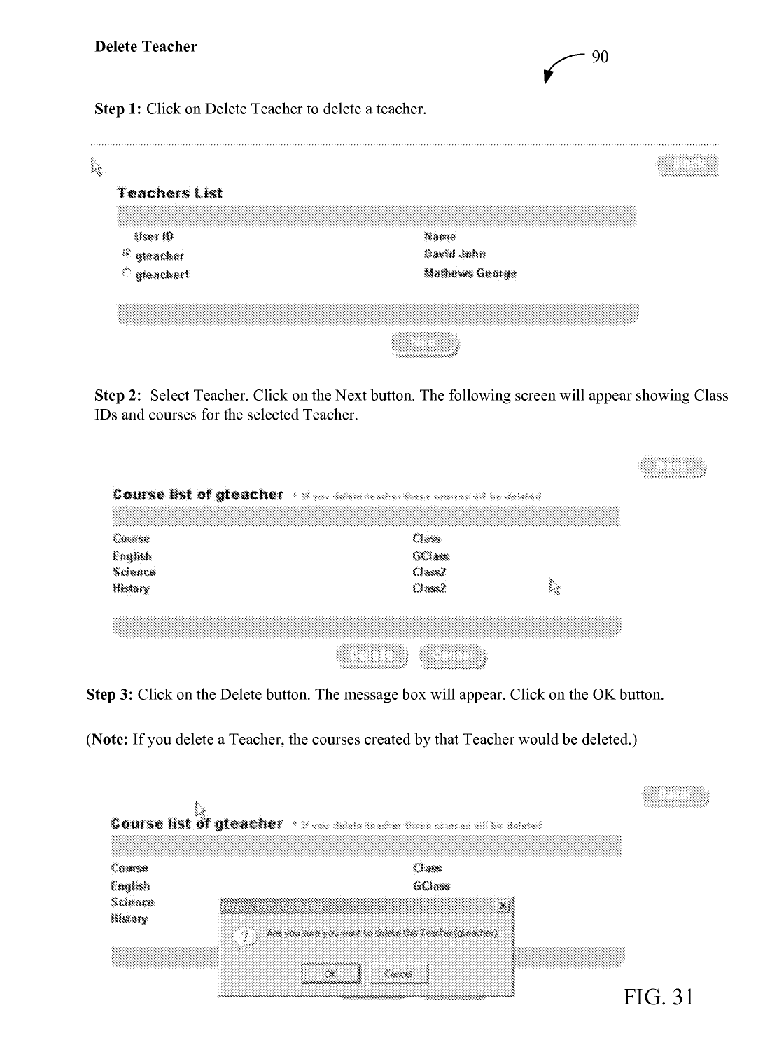

FIG. 31 shows a teacher deletion sequence 90. In the illustrated example, the user may select a teacher, select a Delete button and confirm the deletion.

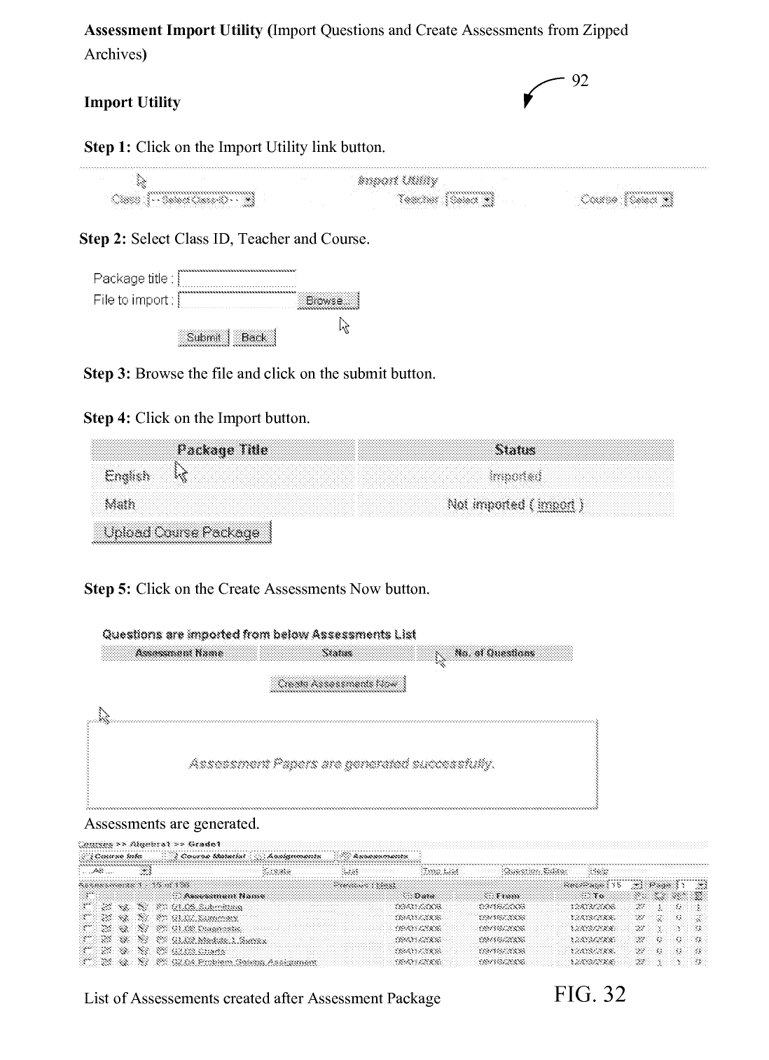

FIG. 32 shows an assessment import sequence 92. In the illustrated example, the user may select course information, select a file to import, select an Upload Course Package button, and select a Create Assessments Now button.

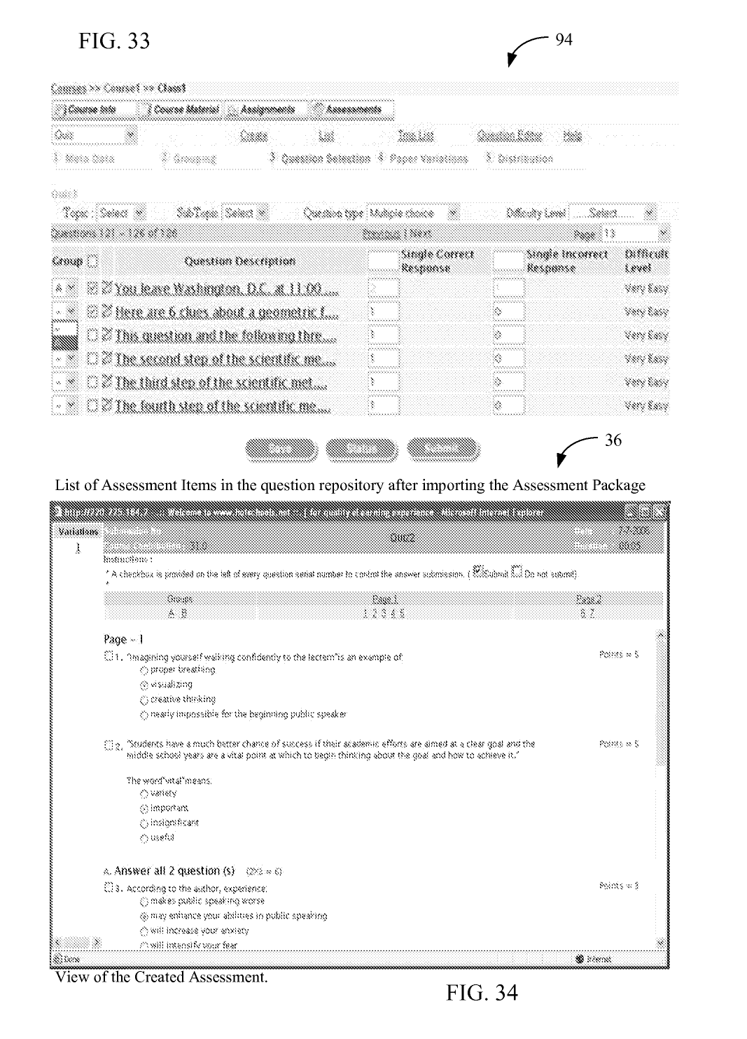

FIG. 33 shows a list 94 of assessment items. In the illustrated example, individual questions may be displayed after being imported along with statistics such as the number of correct responses, the number of incorrect responses, and so forth.

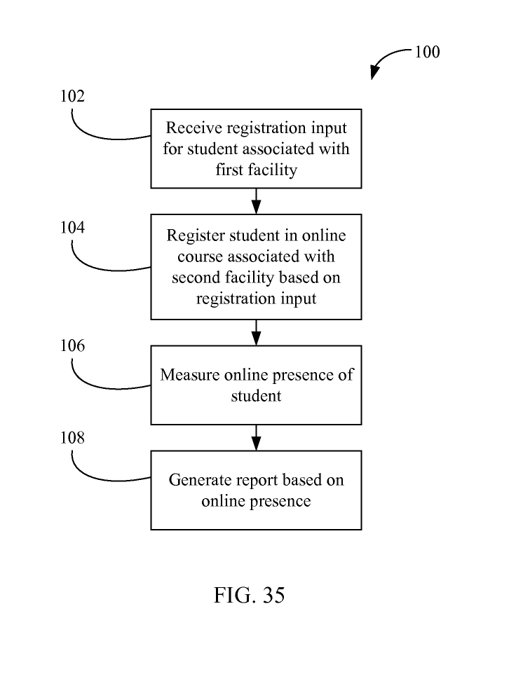

FIG. 34 shows an assessment 96. In the illustrated example, the assessment is configured in the display format that the student experiences.

FIG. 35 shows a method 100 of operating a learning management system. The method 100 may be implemented in executable software as a set of logic instructions stored in a machine- or computer-readable storage medium of a memory such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 100 may be written in any combination of one or more programming languages, including an object oriented programming language such as Java, Smalltalk, C++ or the like and conventional procedural programming languages, such as the “C” programming language or similar programming languages.

Illustrated processing block 102 provides for receiving registration input for a student associated with a first facility. In one example, the registration input includes a K-12 grade level identifier, although the registration input may also be used for adults or for students at the collegiate and/or professional level. The student may be registered in an online course associated with a second facility at block 104 based on the registration input, wherein the online course may be a classroomless (e.g., course based, distance) course. Block 106 may provide for measuring an online presence of the student. For example, the online presence might be measured with respect to the course, a login session, and so forth. Additionally, a report may be generated at block 108 based on the measured online presence, wherein the report can quantify the student's course material usage, assessment usage, assignment usage, e-classroom usage, chat usage, and so forth.

Course Builder

A “course builder” as described herein may be an online course authoring platform designed to empower users to rapidly create dynamic, interactive e-learning content. The course Builder can be designed with non-technical users in mind, allowing users to create rich interactive content online. The course builder may help users make great content quickly, and deliver a high return on investment. The course builder may be delivered as Software as a Service (SaaS). The course builder may feature a highly intuitive user interface, rapid course generation, and automatic generation of navigation elements including chapter and course indices. Courses created with the course builder, may be built in HTML, CSS and JavaScript—standard technologies that work on any intranet, Internet, computer, tablet or Smartphone. Constructed courses may download quickly, run on any web server, and be accessed with any web browser. The course builder may be easy to use, enabling quick development of highly interactive, engaging e-learning content regardless of the user's experience. What You See Is What You Get (WYSIWYG) editing, and step-by-step menus may guide users along and make it easy to create advanced engaging content. Accordingly, the course builder may be ideal for creating all types of e-learning content: Course Material; Quizzes, tests and assessments; Assignments; Converting legacy content to e-learning from PowerPoint.

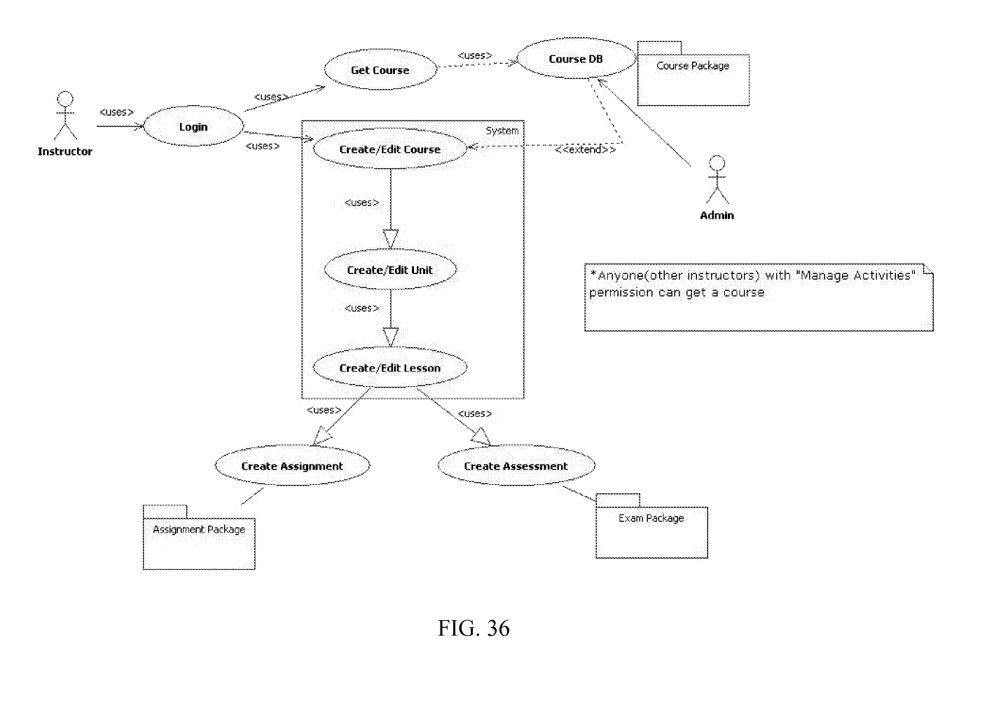

Content creation may be developed for teachers, without computer programming knowledge; easy to use visual content editor—no programming required; upload rich media, including images, video and audio; courses can be created, deployed and modified instantly. The system may follow an intuitive step-by-step process as shown in FIG. 36.

Step 1—Set up a course outline and add an overview of the course: add any prerequisites—the course builder enables the user to set up a suite of courses that work together. Prerequisites ensure competency has been achieved before new courses are undertaken.

Step 2—Add course material add content via a familiar and simple to use WYSIWYG online text editor. Course material can feature rich media, including images, audio and video. Create quizzes for the end of each subject to consolidate learning.

Step 3: Set up an exam. Add individual questions including true/false, matching, ordering, fill in the blank, multiple choice single/multiple answers questions, short and long answer questions. Questions are added with the online text editor. Users can add images and rich media. Users can also specify some questions that they require to be answered correctly.

Step 4—Preview a course. Ensure the course is looking great before it goes live. Of course users can always step back in the process to make edits and updates.

Step 5—Publish a course. Set the course status. Publish the course live. The course is now up and running—it's that easy.

Simply put, the course builder may be capable of creating Course Material, Assignments, and Assessments. Course Material Interface: designed to empower users to rapidly create and deploy online courses. Course Builder is designed with the non-technical user in mind, allowing users to create rich interactive learning experiences online. Easy to use visual content editor—no programming required. Upload rich media, including images, video and audio.

Assignments: The assignment editor is integrated with a full fledge HTML editor, which allows users to create engaging content for the Assignments.

Assessments: The Assessment Editor is integrated with a power full Question Editor which supports most of the Question Types: Multiple Choice Single Answers, Multiple Choice Multiple Answers, Yes or No, Fill In the Blanks, Ordering, Matching, Short/Essay Type. The Question's created with the Question editor can be used to create Assessments. The course materials can easily be imported to the LMS.

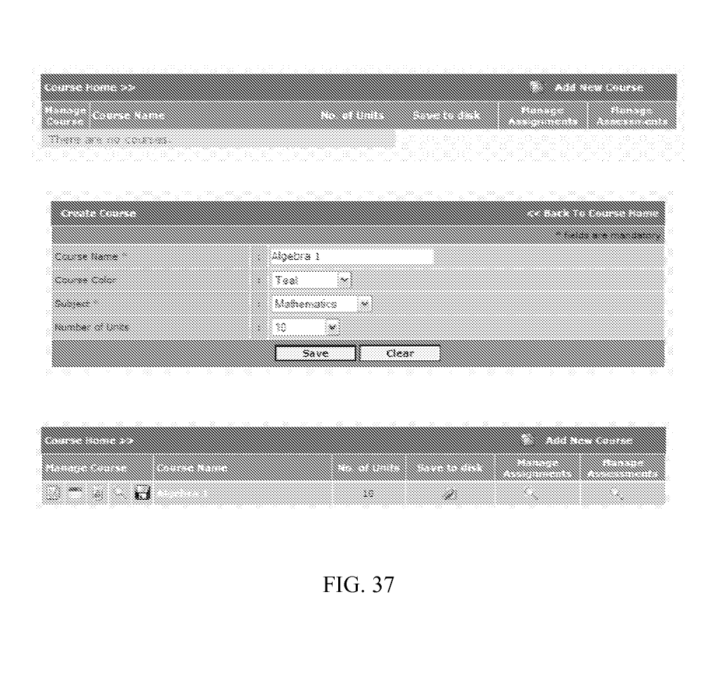

As shown in FIG. 37—Step 1: Click “Add New Course” to enter course details. Step 2: Enter “Course Name.” Step 3: Select the “Course Color”. [Course Color represents the course template's color]. Step 4: Select “Subject.” Step 5: Select “Number of Units” to have in the Course. [It is not mandatory to select the Number of Units; users can add or remove the Units later] Step 6: Click “Save” to create the course shell. [Course shell is course workspace without the course content.].

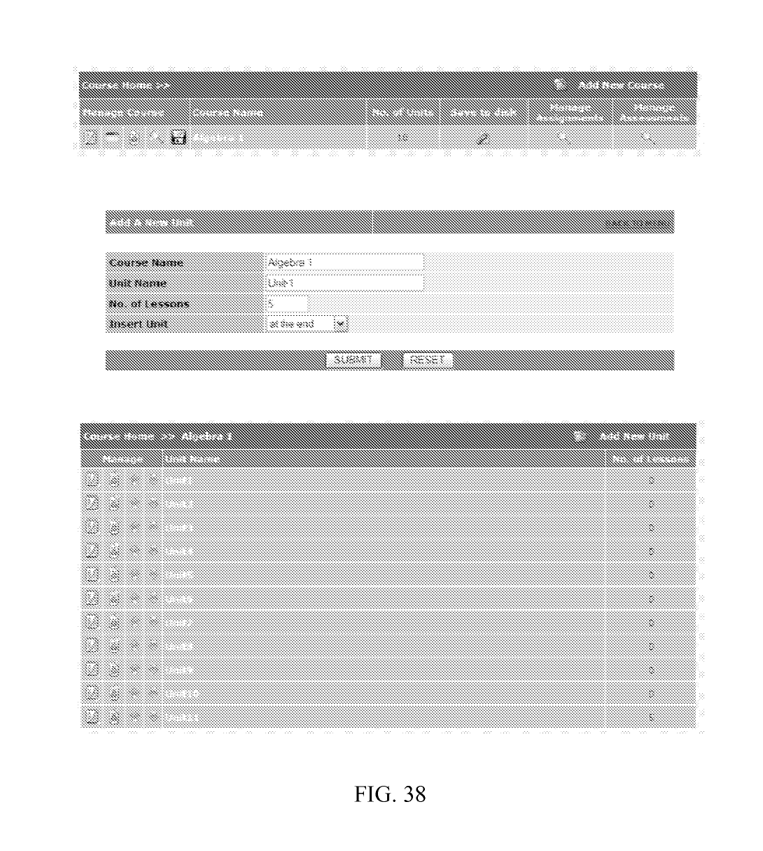

As shown in FIG. 38—Step 1: Click on the “Course Name” Step 2: Click “Add New Unit” to add a Unit to the Course. Step 3: Enter the “Unit Name.” Step 4: Enter “Number of Lessons” [It is not mandatory to add Number of Lessons users can add later]. Step 5: Select where to Insert /Create the Unit. Step 6: Click “Submit” to Insert/Create the Unit.

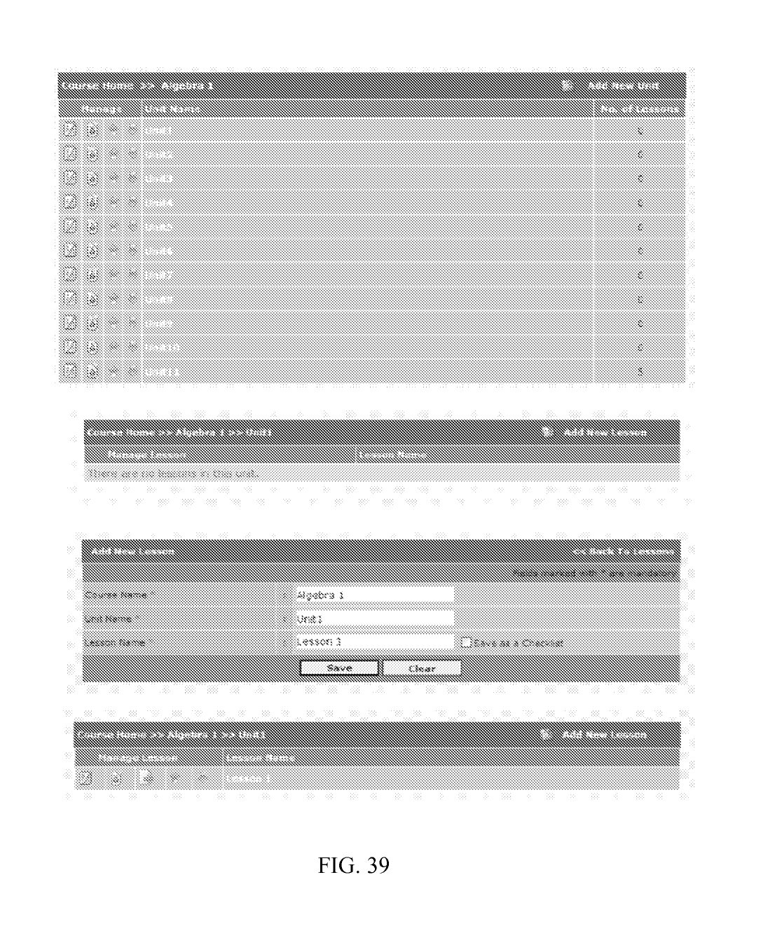

As shown in FIG. 39—Adding Lessons to the Units. Step 1: Click on the Unit Name to view the Lessons in the Unit. Step 2: Click on “Add New Lesson” to add Lessons. Step 3: Enter “Lesson Name.” Step 4: Click “Save as a Checklist” only if users want to create a Checklist. Step 5: Click “Save” to Save the Lesson.

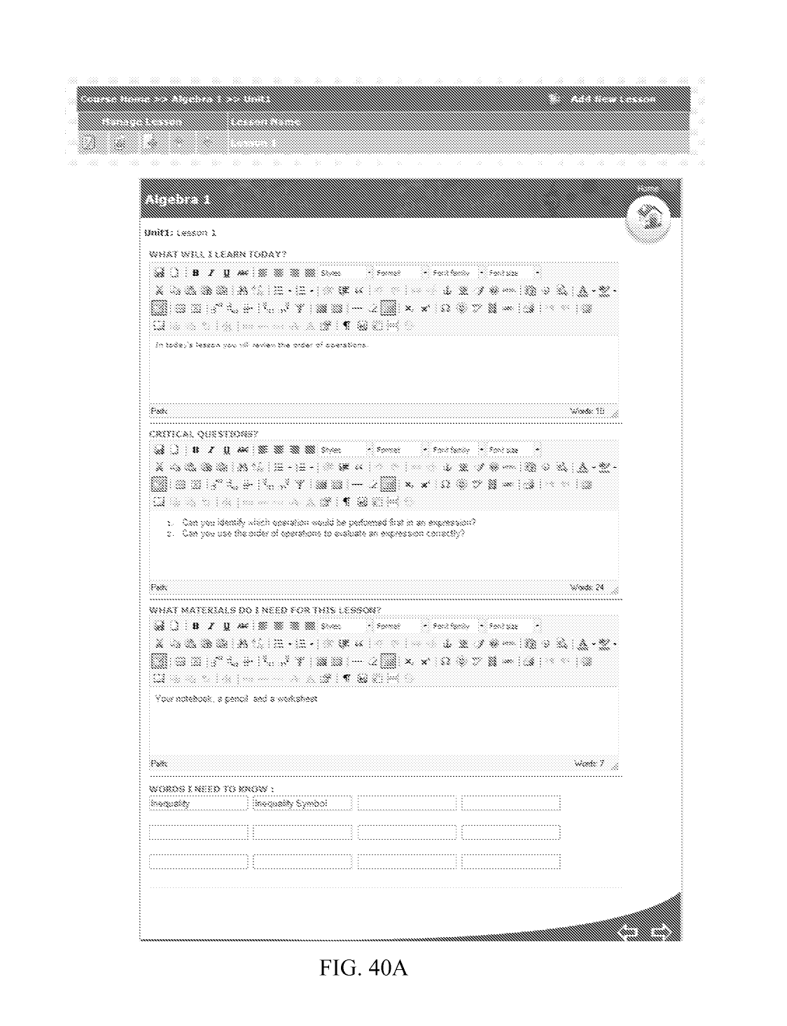

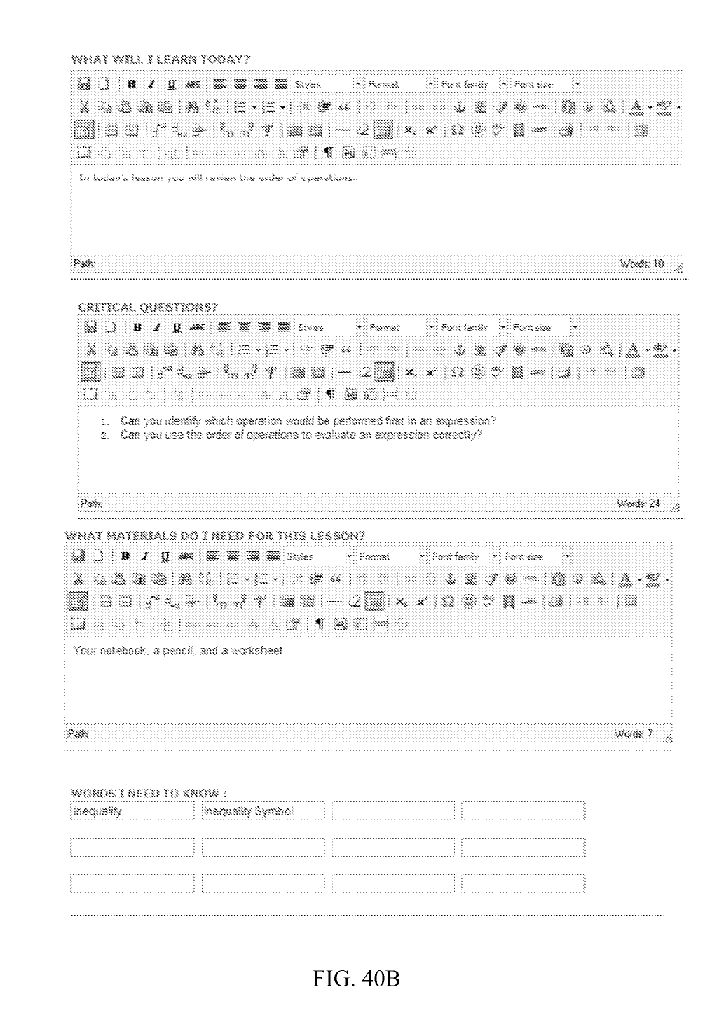

As shown in FIG. 40A—Adding Content in the Lessons. Step 1: Click on the “Lesson Name” to view the Lessons Structure.

As shown in FIG. 40B—Step 2: Enter in the Editor “What will I learn to today” [Here users may need to enter what the student(s) will learn in this lesson]. Step 3: Enter in the Editor “Critical Questions” [Here users may need to enter what Critical Questions the student(s) learn in this lesson]. Step 4: Enter in the Editor “What materials do I need for this lesson” [Here users may need to enter what materials (ex Pencil, Eraser, Etc . . . ) the student(s) needs to complete this lesson. Step 5: Enter “Words I Need To Know” [Here users may need to enter the Words student(s) will be learning in this lesson]. Step 6: Click on the Right Arrow Button at the extreme right corner of the page to Save and continue to the next step.

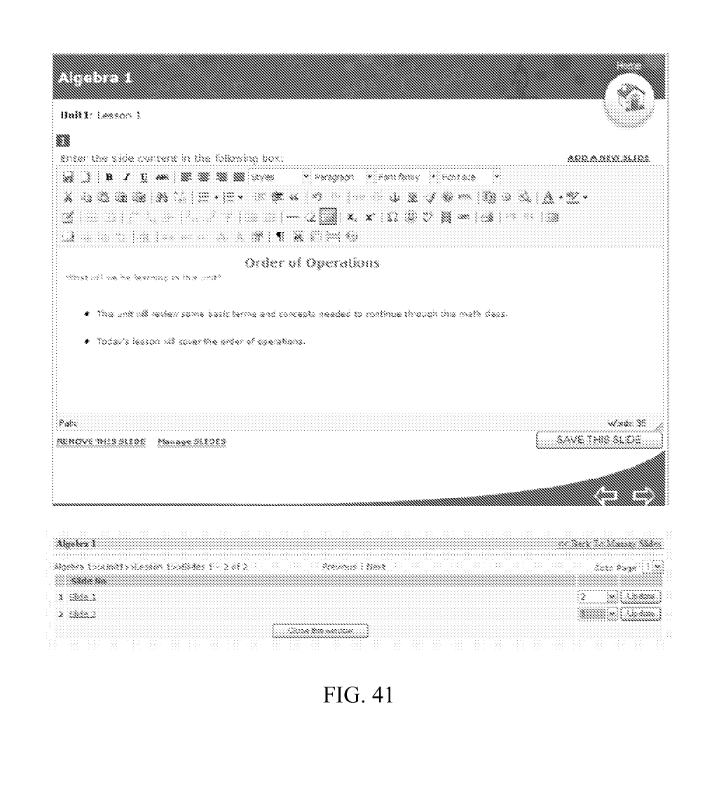

As shown in FIG. 41—Creating Lesson Slide, Step 1: Enter in the Editor the Lesson content [Users can create the Lesson Content in multiple slides.] Step 2: Click on “Save this Slide” to save the slide. Step 3: Click on “Add new Slide” to add new slide. Step 4: Click on “Remove this Slide” to delete the current Slide. Step 5: Click on “Manage Slides” to change the order of the Slides. Step 6: Click on the Right Arrow Button at the extreme right corner of the page to Save and continue to the next step.

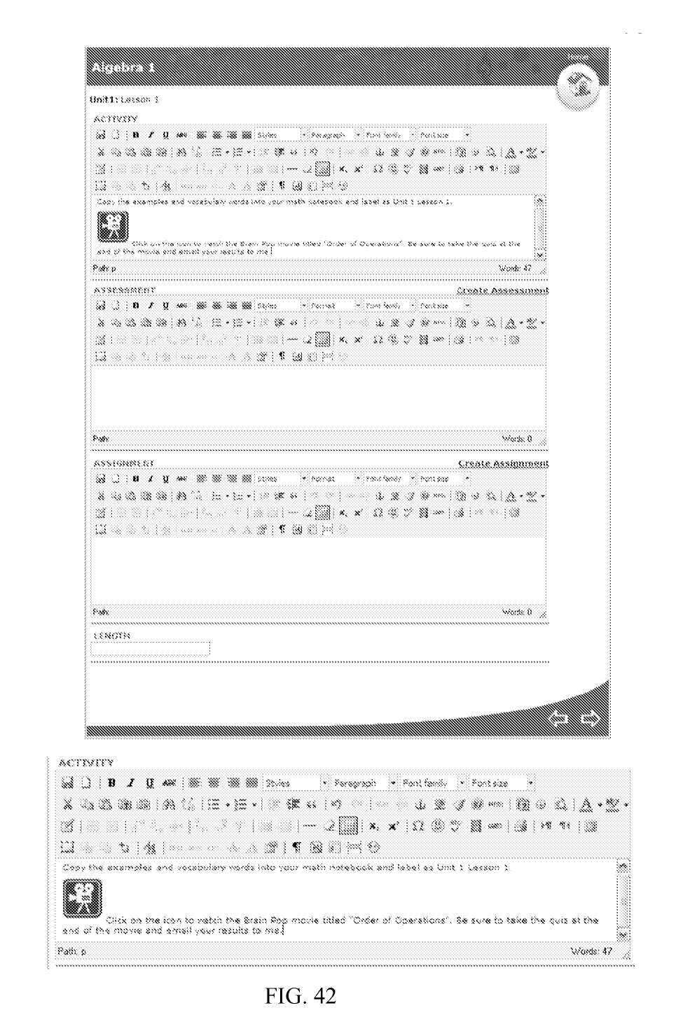

As shown in FIG. 42—Creating Activities. Step 2: Enter in the Editor “What will I learn to today” [Here users may need to enter what will the student(s) learn in this lesson]. Activity: Step 1: Enter in the Editor “Activities” [Here users can create links to external resources, Audio Video files, Presentations, etc.]

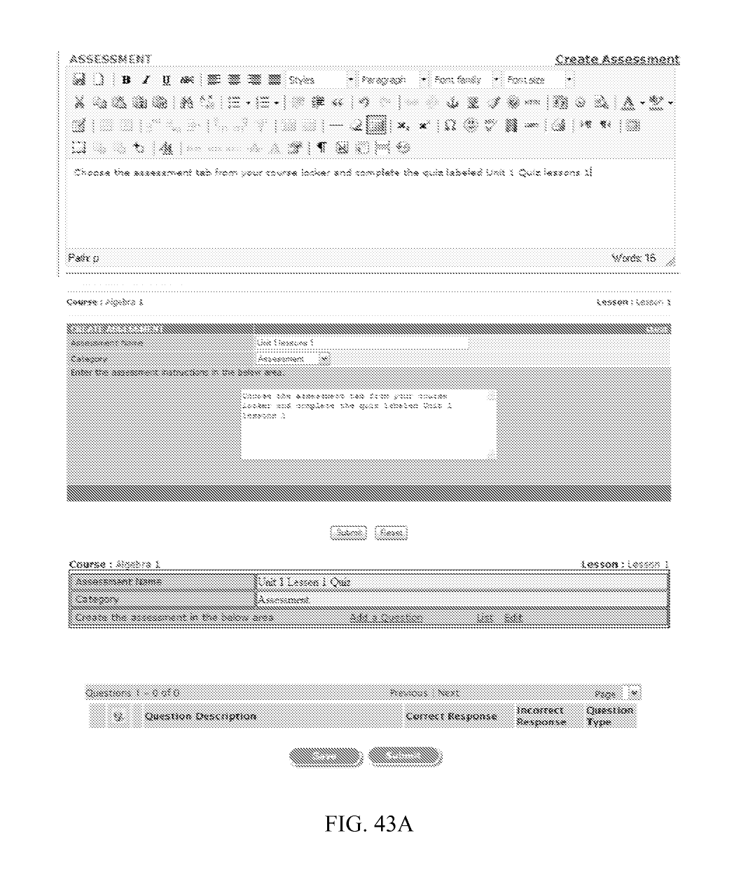

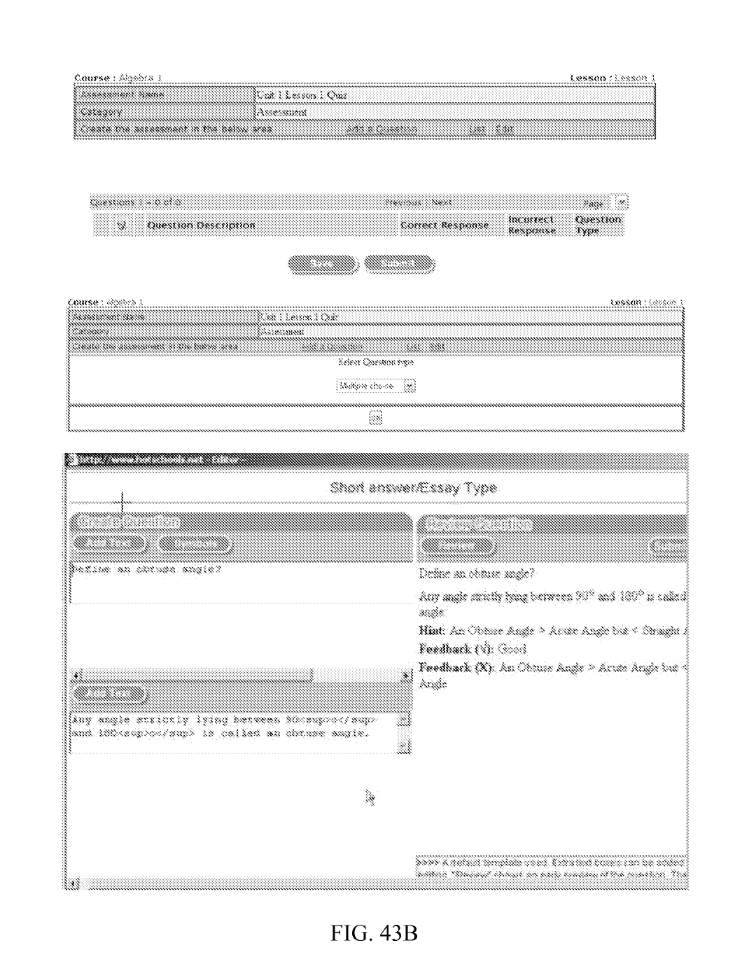

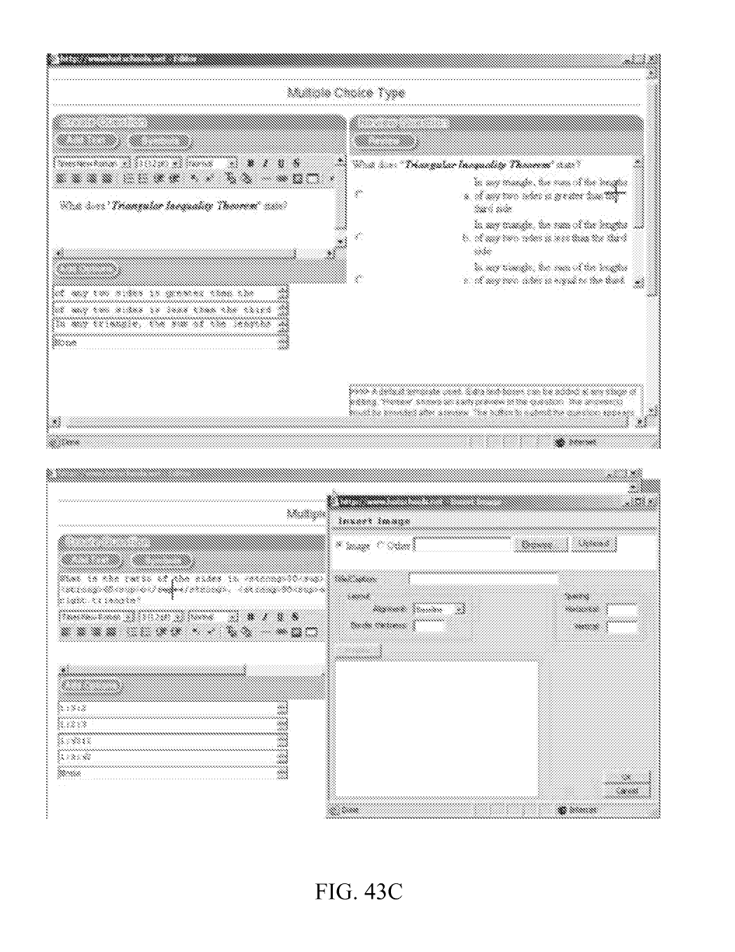

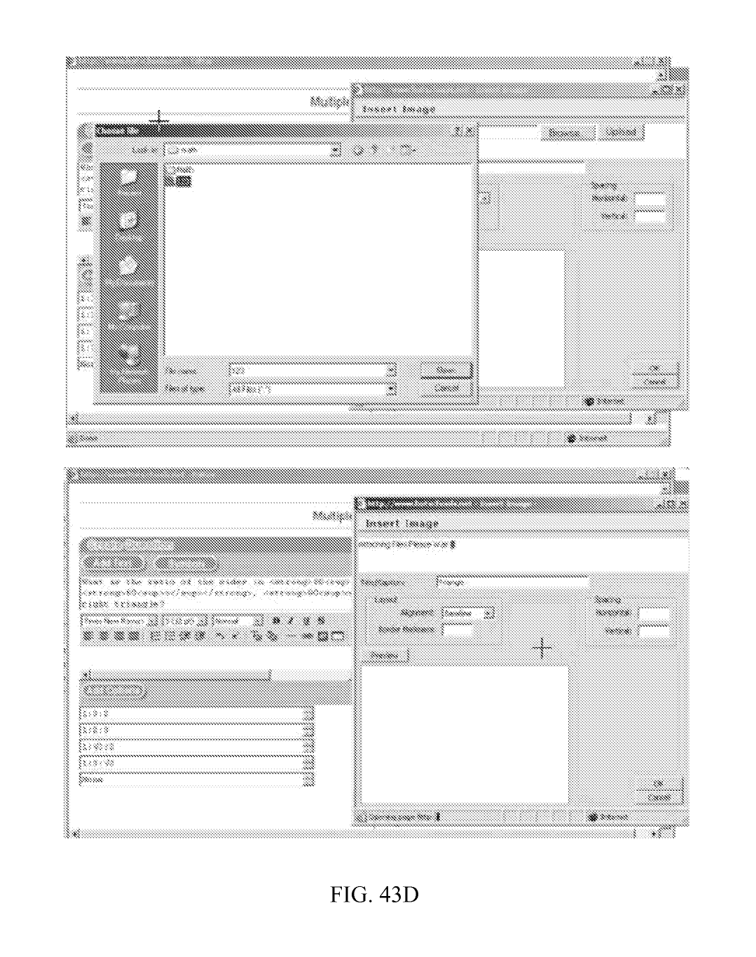

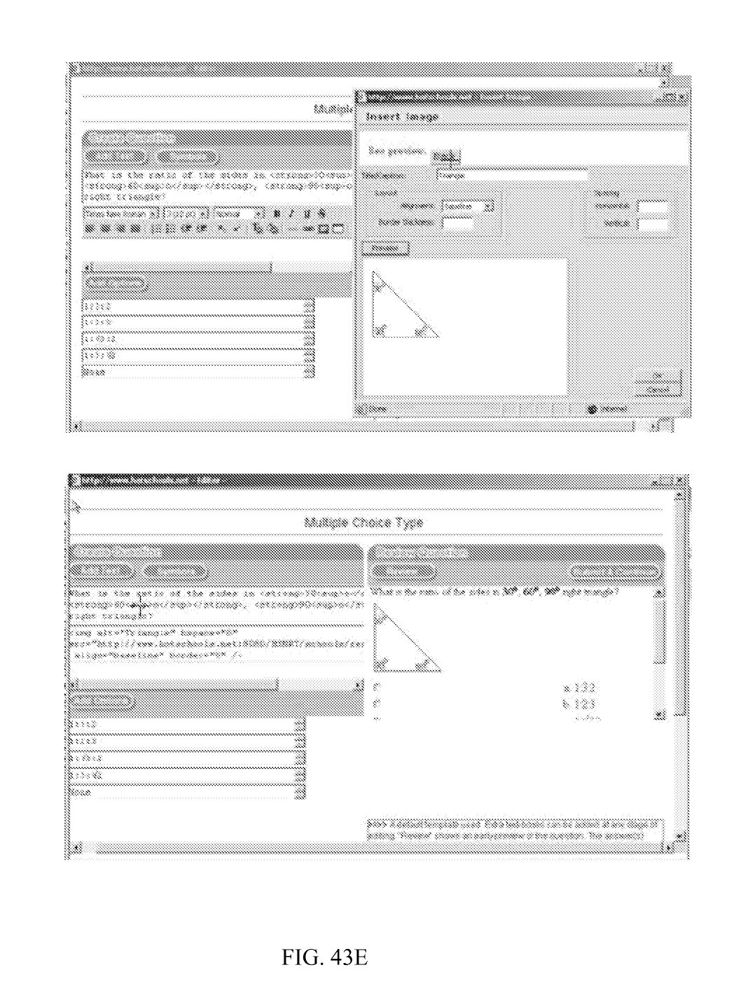

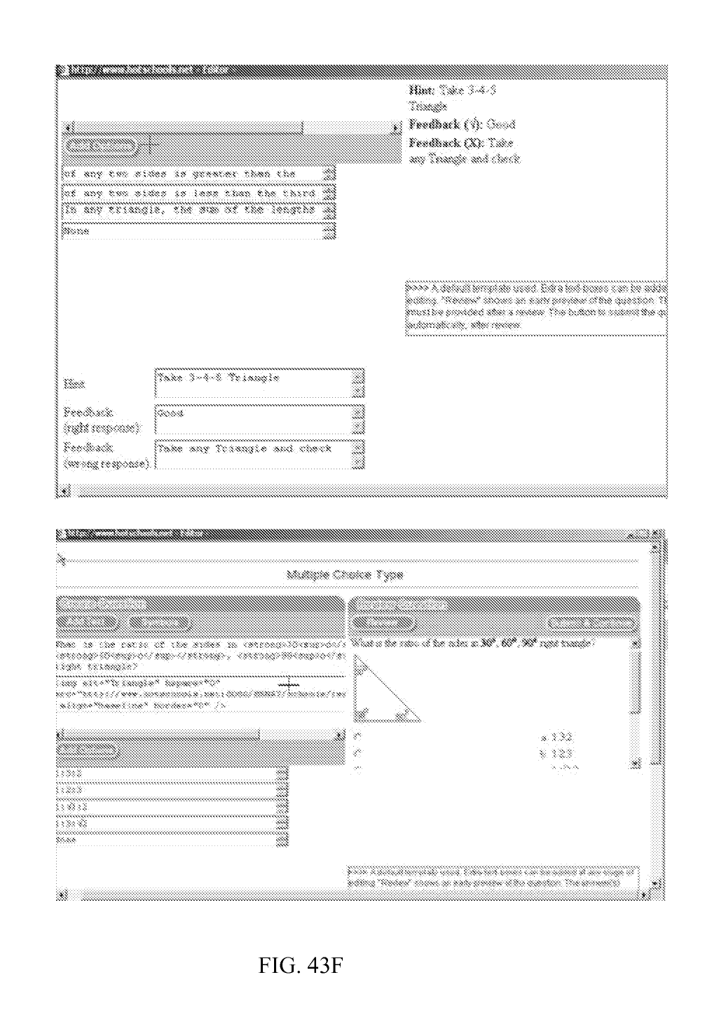

As shown in FIG. 43A—Create Assessments. Step 1: Enter in the Editor “Assessments” Instructions [Here users can add information about the Assessments]. Step 2: Click “Create Assessment” to create an Assessment. Step 3: Enter “Assessment Name.” Step 4: Select the “Category Assessment” in which the user wants to create an Assessment. Step 5: Enter the “Assessment Instructions.” Step 6: Click “Submit” to create the Assessment.

As shown in FIG. 43B—Adding Assessment Questions. Step 1: Click “Add a Question”. Step 2: Select Question Type “Multiple Choice” from the list and press “OK” button. Step 1: Enter a question of the topic/subtopic related type. Step 2: Click on the “Symbols” button to add symbols to the question.

As shown in FIG. 43C—Step 3: Double click on the question area to open the HTML Editor. Step 4: Users can add images to the question in the HTML Editor. Step 4.1: Click on the [symbol] image (upload icon) in the HTML Editor to upload an image.

As shown in FIG. 43D—Step 4.2: A popup window opens with the title insert image. Step 4.3: Click on the “browse” button to select the image file from the Local Disk.

As shown in FIG. 43E—Step 4.4: Set the Title/Caption and Alignments for the image and click on the “upload” button to upload the image. Step 4.5: Click on the “preview” button to preview the image.

As shown in FIG. 43F—Step 5: Enter the Options to the question in the option area. Step 6: If users want more options to the question, click on the “Add Options” button. Users can add multiple options here. Step 7: Add hints and feedback to the right/incorrect responses. Step 6: Click on the “Review button on the Review Question tab. It displays the question and options entered. Step 7: Select the Correct option for the answer. Step 8: Click on “Submit and Continue” button to submit the question.

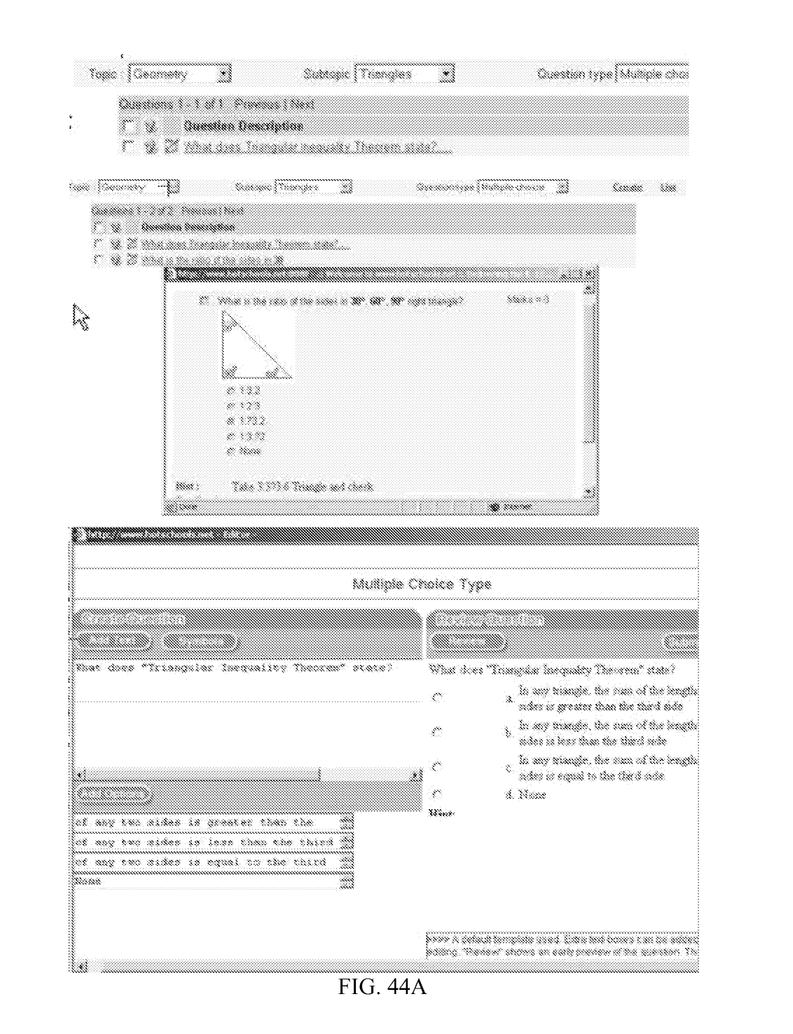

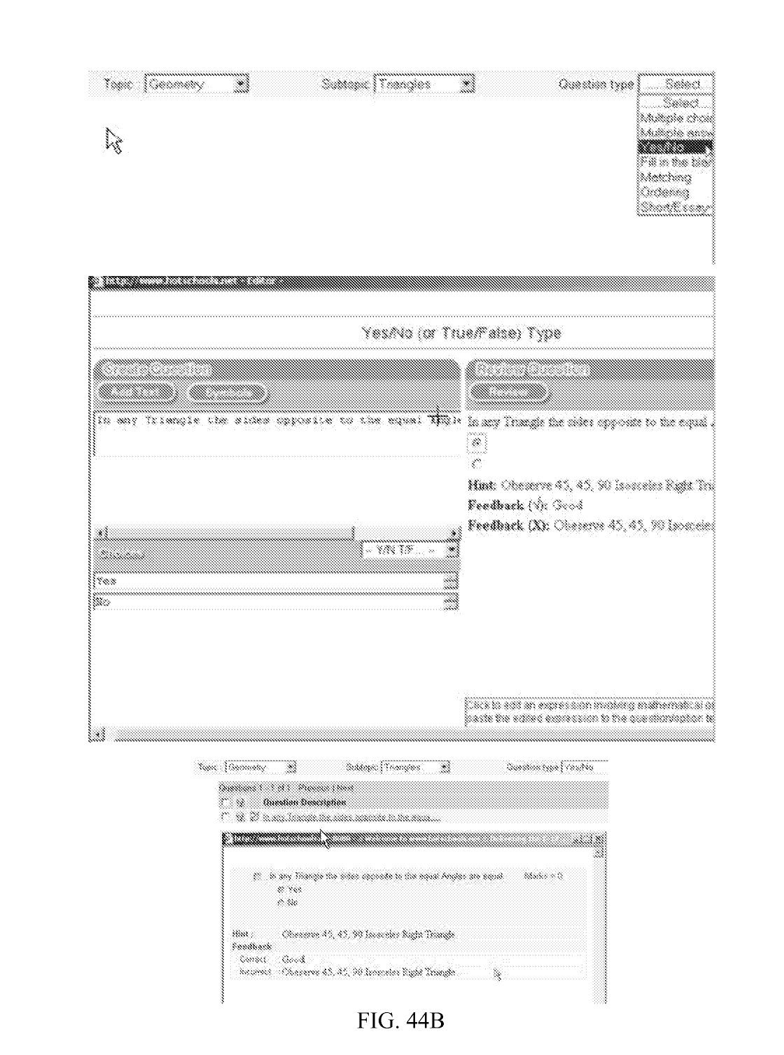

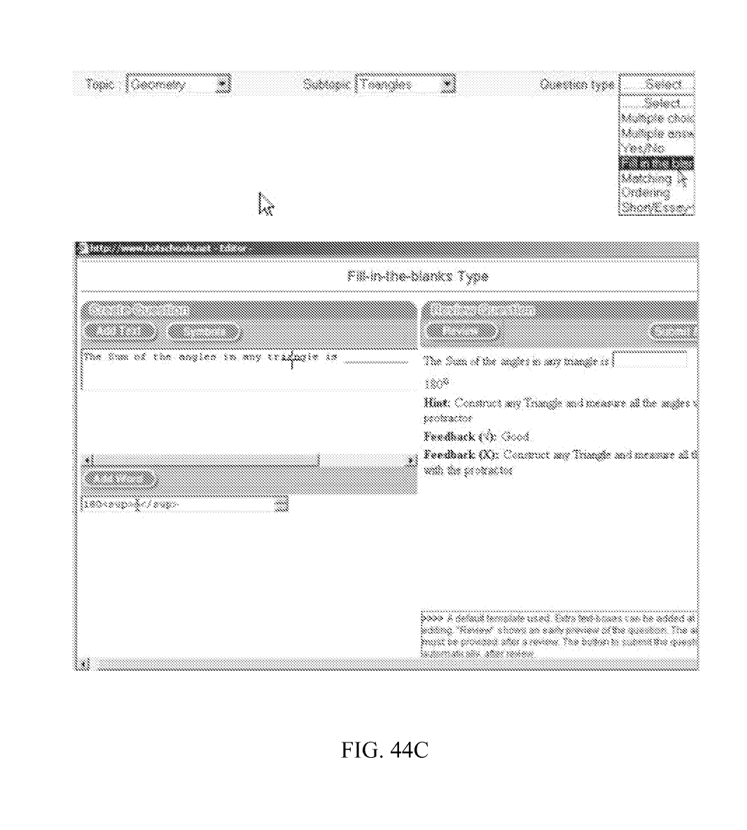

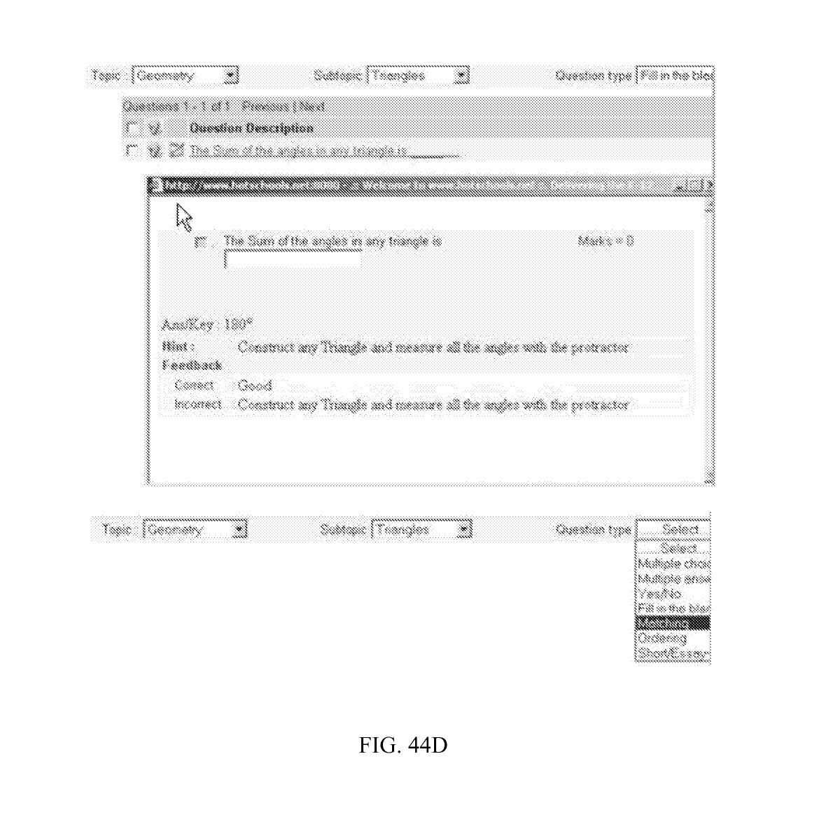

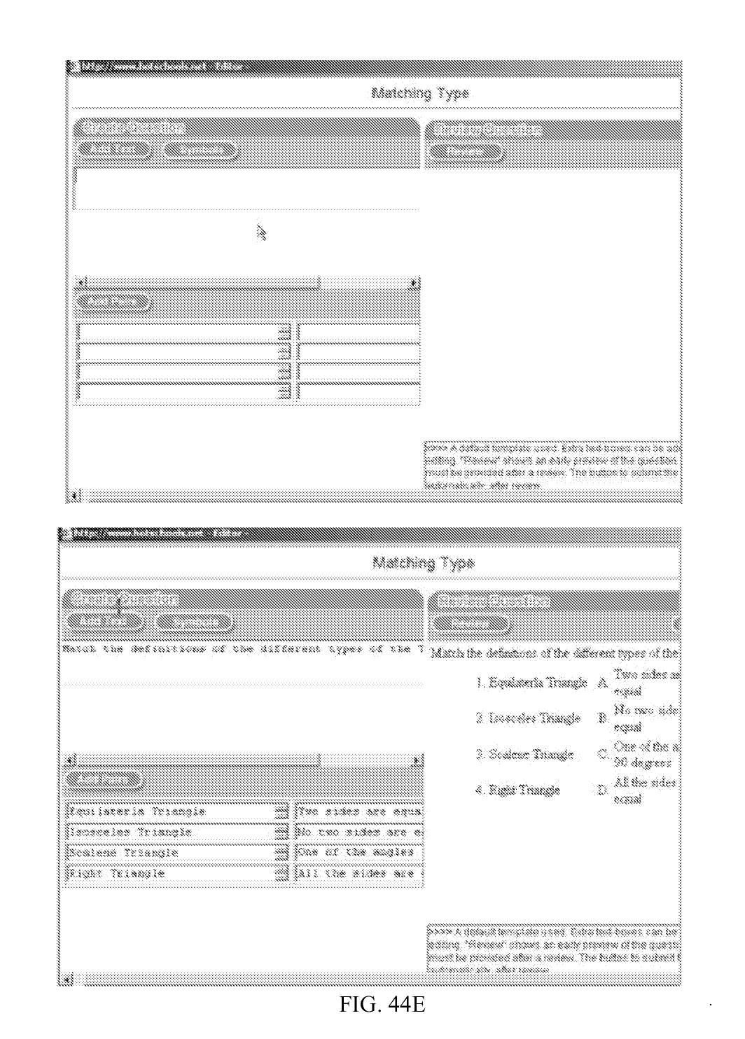

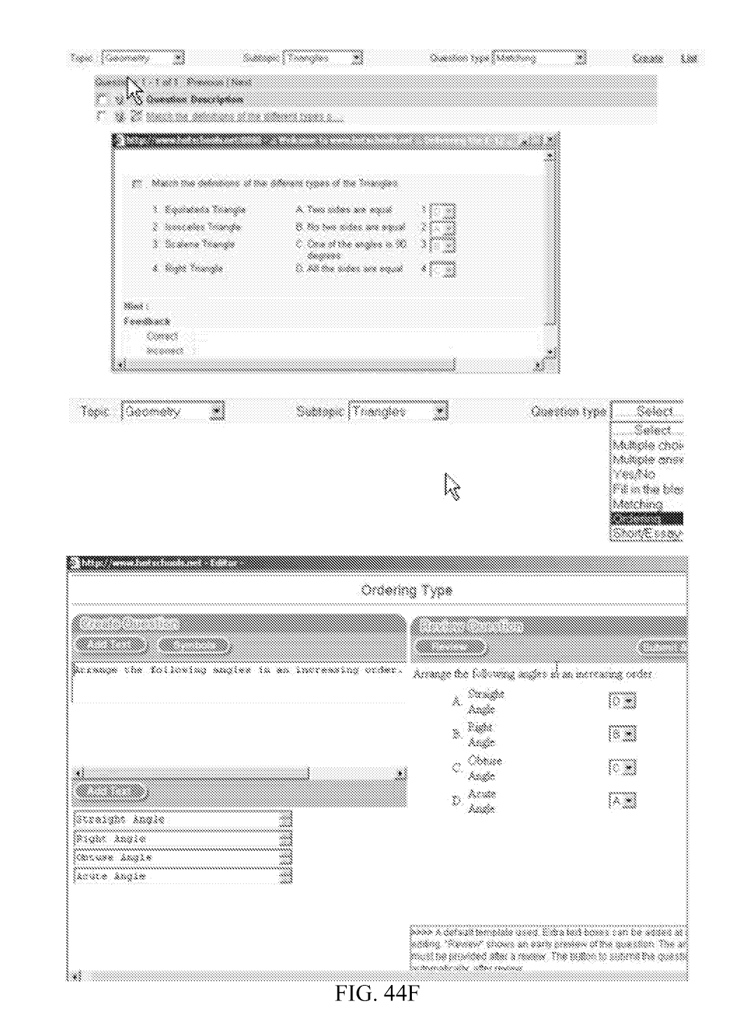

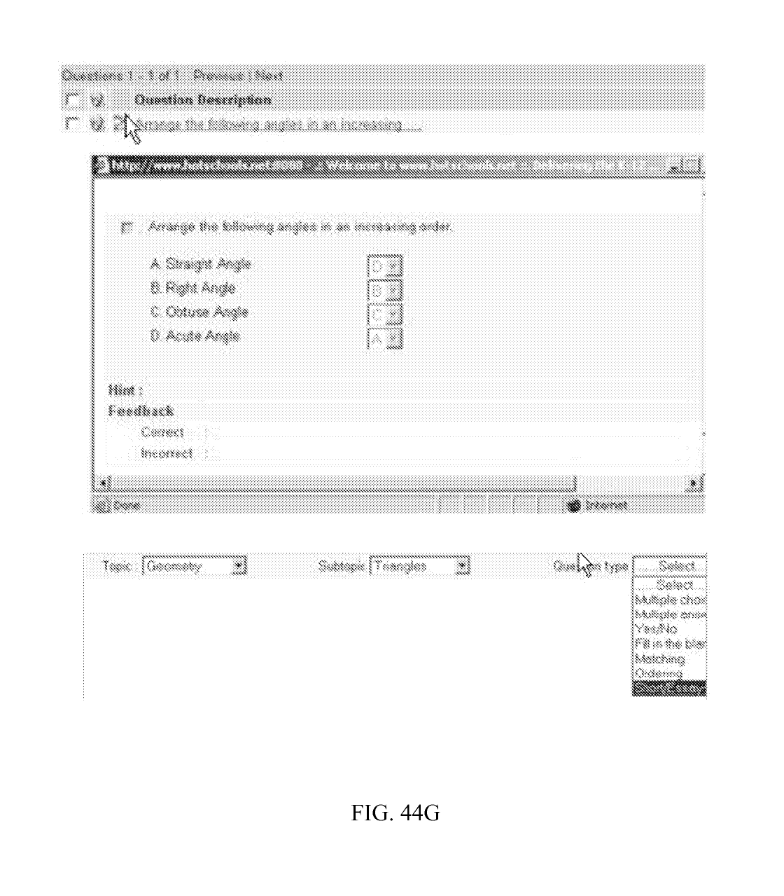

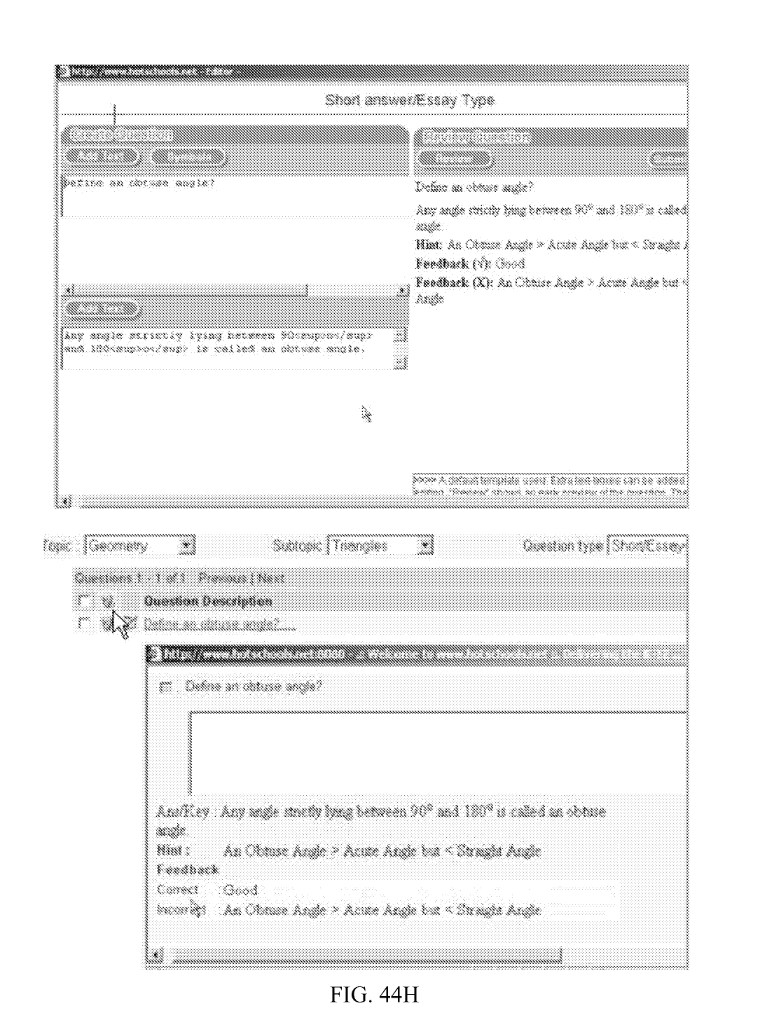

As shown in FIG. 44A—After submitting the question the user will return to the screen where it can be viewed. Step 1: Click on the question text to view the question. Step 2: Click on the [symbol] icon to edit the question. Step 3: The user will return to the following screen: “Step 3: Edit the question and click “Submit and Continue” button to update the question.” Step4: Click on the [symbol] icon to delete the question. Step 5: A confirmation box appears and confirms that users are deleting the question.

Question Type 2: Multiple Answers, Follow Question Type 1 to create Multiple Answers. When users select the correct answer users should select Multiple Answers to the questions.

As shown in FIG. 44B—Question Type 3: Yes/NO: Step 1: Select the Question Type Yes/No. Step 2: Enter a question for the topic/subtopic related type. Step 3: Users can add additional text and symbols to the question by selecting the options Add Text and Symbols. Step4: Double click in the question area to open the question in the HTML Editor. Step 5: Enter the options to the question in the option area. Step 6: If users want another option, click on the option Yes/No and select another. Step 7: Click on the “Review” button on the Review Questions. This should display the question and options entered. Step 8: Select the Correct option for the answer. Step 9: Click “Submit and Continue” button to submit the question.

As shown in FIG. 44C—Question Type 4: Fill in the blanks Step 1: Select the Question Type Fill in the Blanks Step 1: Enter a question for the topic/subtopic related type. Step 2: Users can add additional text and symbols to the question by selecting the options Add Text and Symbols. Step 3: Double click in the question area to open the question in the HTML Editor. Step 4: Enter the Options users want to put as a blank. Step 5: Click on the “Review” button on the Review Questions tab. This should display the question and options entered. Step 6: Click “Submit and Continue” button to submit the question.

As shown in FIG. 44D—to view the question made click on the question. Also, the selection of “Matching” in the question type pull down menu, to create a “Matching” type question.

As shown in FIG. 44E—Selecting the Question Type Matching. Displays the “Create Question” screen. Step 1: Enter a question for the topic/subtopic related type. Step 2: Users can add additional text and symbols to the question by selecting the options Add Text and Symbols. Step 3: Double click in the question area to open the question in the HTML Editor. Step 4: Enter the Options users want to put for Matching. Step 5: Click on the “Review” button on the Review Questions tab. It should display the question and options entered. Step 6: Match the correct options. Step 7: Click “Submit and Continue” button to submit the question.

As shown in FIG. 44F—to view the question made click on the question. Also, the selection of “Ordering” in the question type pull down menu, to create an “Ordering” question. Displays the “Create Question” screen. Step 1: Enter a question for the topic/subtopic related type. Step 2: Users can add additional text and symbols to the question by selecting the options Add Text and Symbols. Step 4: Enter the Options users want to put for Ordering. Step 5: Click on the “Review” button on the Review Questions tab. This should display the question and options entered. Step 6: Match the correct options. Step 7: Click “Submit and Continue” button to submit the question.

As shown in FIG. 44G—to view the question made click on the question. Also, the selection of “Short/Essay” in the question type pull down menu, to create a “Short/Essay” type question.

As shown in FIG. 44H—Selecting the Question Type Short/Essay. Displays the “Create Question” screen. Step 1: Enter a question for the topic/subtopic related type. Step 2: Users can add additional text and symbols to the question by selecting the options Add Text and Symbols. Step 3: Double click in the question area to open the question in the HTML Editor. Step 4: Enter the Answer Key, which will be used when evaluating the Short/Essay Type Question. Step 5: Click on the “Review” button on the Review Questions tab. This should display the question and Answer Key entered. Step 6: Click “Submit and Continue” button to submit the question. Step 7: Click on question to view the question.

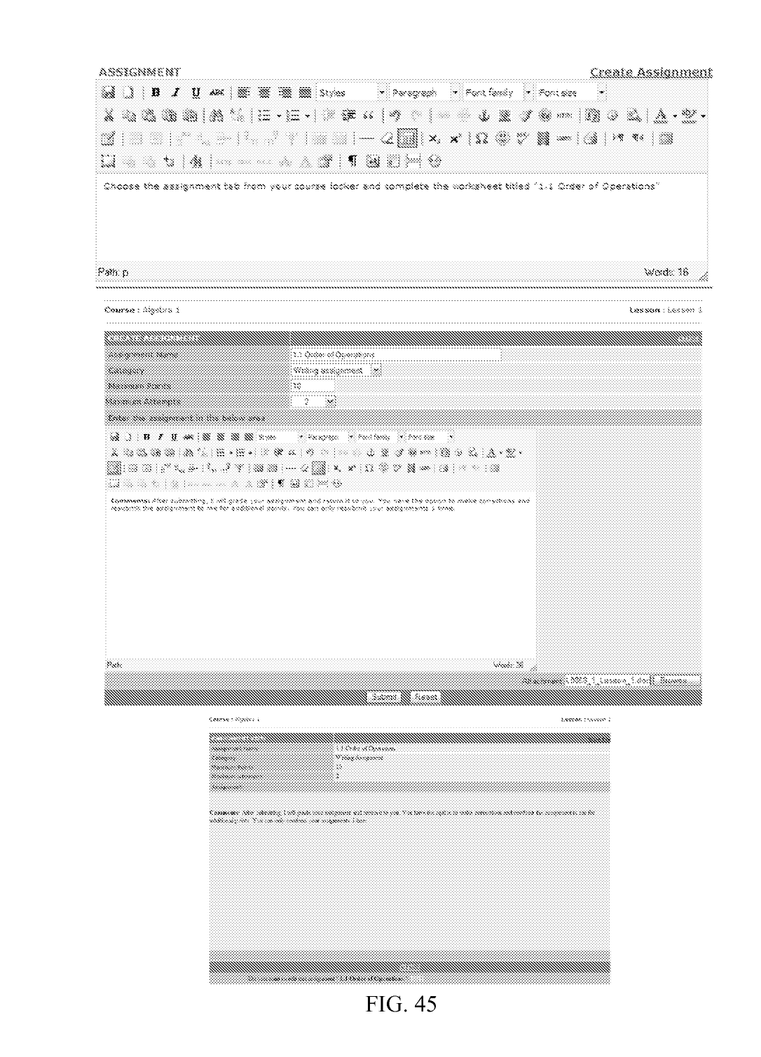

As shown in FIG. 45—To create assignments. Step 1: Enter in the Editor “Assignment” Instructions [Here users can add information about the Assignment(s)]. Step 2: Click “Create Assignment” to create an Assignment. Step 3: Enter “Assignment Name”. Step 4: Select the “Assignment Category” in which users want to create an Assignment. Step 5: Enter the “Maximum Points”. Step 6: Select the “Maximum Attempts”. Step 5: Enter the “Assessment Instructions”. Step 6: Brows and select the Assignment Work File as Attachment. Step 6: Click “Submit” to create the Assignment.

A method of delivering online learning in a classroom based learning system may be a collaborative learning experience in which teachers and students work together online as in a brick and mortar classroom. Moreover, techniques may provide for importing IMS-QTI (Question and Test Interoperability) compliant XML into the learning management system (in the IMS QTI specification, metadata is used for describing and cataloguing assessment items and presented in XML format). Moreover, the IMS-QTI package can contain individual assessments, which can be imported into the system. Additionally, the system may read the XML data and create individual assessments with the questions stored in a question repository.

In addition, techniques described herein may provide for delivering online learning in a school based environment, where groups of schools can deliver online learning simultaneously. For example, students from school “A” can take courses from School “B” and vice-versa. The system enables users to establish workflow and define access rights in the development and implementation of courses. Additionally, the system allows users to create course material, assignments, and assessments.

The system may also provide a set of templates that may be chosen for courseware, or users may request a set of custom templates. Either way, once the set of templates are chosen, staff can simply select the proper template and begin entering content. Moreover, the system enables a team to create navigation schemes so there are no screen order or navigational issues.

As a web-based application, the system can grant access to instructional designers, multimedia developers and other creative teams to simultaneously allow collaboration on each screen for faster execution. Additionally, the System may be designed with the non-technical user in mind, allowing them to create rich interactive courseware. Indeed, any instructor/educator with minimal knowledge computers may be able to create and deploy courses. Once the courseware is ready, users can simply click a button to export all the content, assets and designs in one neat package.

Thus, the system supports course based (e.g., classroomless) and class based systems, wherein multiple schools may work in a single hosted environment. The system may also have an option where learners can take courses from other schools hosted in the same hosting environment. Indeed, the system has capability to import IMS-QTI assessment packages and can create any number of assessments with a single click. Techniques described herein can also provide role-based access for the individual learner or to a group.

The system may have a very robust question editor capable of creating numerous different types of inquiries. The system also supports importing student registrations from district information systems. Additionally, techniques provide for a classroomless online training system that results in an environment similar to classroom.

In addition, the system may provide the complete training, grading, assessments, assignments, homework and project submissions, etc., and other daily school programs and schedules, notice boards, student monitoring and other student attendance programs in the portal. Moreover, the system can provide an interface for the complete school academic curriculum for all grades within the web portal.

Techniques described herein also provide for a dashboard where the student awards and achievements, monthly progress reports may be updated. Such an approach provides good source for parents to see their children status and can also compare with others. Additionally, the system may provide an interface where students can be given information about artistic events held at school and competitions held at other campuses for the academic year. The system may also enable students, teachers and management were to add comments and update information to for viewing by a main administrator, as well as to update any other important information about the event. All these changes can be updated in the event calendar.

The system may also provide information about different programs conducted in school for students. For example, students may be given different options to communicate with their respective subject teachers to get their doubts clarified. Indeed, feature that may particularly facilitate this feature is a live board, wherein the student and/or teacher can put descriptions on the live board for discussion. Additionally, teachers can pull multiple students into the live board e-classroom session and can explain concept on board, wherein students may chat and see the video of the presenter in the same window. Such a feature may have the look and feel of the teacher explaining the concept to the students directly, posing questions to the students and receiving answers back very similar to a traditional regular class room.

Later, the teacher may create an assignment for the students to work in the create course builder feature, upload the assignments and send messages to the students of the classroom in order to inform them about the submission end date and time (e.g., time for students to submit their responses).

In addition, the results for submitted assignments and their marks may also be updated in the student reports page, wherein students may be provided with an interface for viewing the courses in which they are registered, the assignments and assessments details, etc. Students may also be given training tutorials, wherein access is provided to download and study.

Additionally, the system may include an interface for teachers/administrators to manage courses. This interface can provide options to modify permissions related to course manuals. Various report options may be provided for teachers and students to view. The reports can be categorized as grading reports, course related reports and some miscellaneous reports.

Course related reports may provide information about available courses, grading schema, assignments available, marking periods and some other reports that deal with student grade reports based upon assignments submitted and other results information. The system may also provide information about the student login information such as which pages student has viewed, how many hours the student is live and worked on the courses and training, etc.

Indeed, students and teachers may be provided with live help to discuss access problems or any other technical issues with teachers and also with the maintenance staff 24/7.

Simply put, the system may be developed with the education community in mind. As a result, authentication features in the system can be very simple and easy to use. The system may be offered as a hosted solution, in which case it hosts the entire application for the Institution. It can also be installed entirely on the client's server on premises with online technical support using features such as live web-based support, by telephone and using virtual workspace in order to minimize costs. Thus, techniques described herein may provide for a high quality, easy to use, cost effective system that meets the needs of future teachers and learners.

The system may be a comprehensive e-learning solution offering a courseware delivery and development system, management and administration, custom assessment design and collaboration tools—all via the Internet. Additionally, delivering online learning in a classroom based learning system can be a collaborative learning experience in which teachers and students work together online as in a brick and mortar classroom.

Moreover, such an approach can reflect on students learning and the impact of their actions. Accordingly, students can work in collaborative groups and use technology to tackle real-world issues in the context of their school. The system may give students the structure, support, checkpoints, and tools to get their work done successfully, while allowing them enough freedom to be self-directed, creative, and inspired.

More particularly, the system may provide all the necessary tools and resources for educators to deliver, manage online classes and guide students toward ultimate success. The courses created by teachers may be for student learning as well as staff development.

In addition, techniques described herein may provide benefits such as document sharing, Internet-based meetings, information sharing, and person-to-person voice communication over the Internet. With easy to use, innovative teaching tools, thorough training and ongoing support to the learning community, the system may be a dynamic educational solution that meets the instructional challenges of future generations so that more students can experience higher levels of achievement and success.

The system may also include is a natural and intuitive user-friendly interface, wherein only negligible amount of training for the user are required. Additionally, the system may provide all the necessary tools and resources for teachers to deliver and manage online classes and guide students toward ultimate success.

Tools and resources may include, but are not limited to:

HTML authoring, document management, courseware management, online course delivery,

Online/offline assessment and evaluation, with integration of state standards

Reusability: learning resources form a repository of reusable components,

Third party audio/video solution integration,

Guided +free access to learning resources, assessment with feedback for pupils

Communication tools, including presentation sharing, audio video chat with shared white-board, forum, email, etc.

Additionally, features may include:

Conference Services (e.g., enabling school administrators to establish and conduct audio and video based, real time online meetings with an individual teacher or student, or multiple teachers or other administrators),

Online Assessment Manager (e.g., enabling teachers to create their own exams and launch them online to their students using the web),

Online Question Editor (e.g., enabling teachers to create their own questions (test items) and add them to their personal question banks using a web-based interface).

Online Courseware Manager (e.g., enabling teachers to create and launch their own custom courses on the Internet, using wizards that are very easy to understand).

Self Test option (e.g., enable a teacher to create and distribute practice assessments to students. Such a feature may encourage students to practice, learn, and apply basic-to-advanced skills and concepts integral to their educational success)

Performance Evaluation (e.g., evaluate student and the overall class performance by calculating the average test scores in an electronic grade book. Options may be available to export performance data in various standard data formats and graphical presentations),

Audio Video Chat with White Board (e.g., enable online communication between teachers, teachers and classes, and subject matter experts),

Virtual Classrooms (e.g., enable teachers to establish and conduct audio and video based real time online classes with an individual student, or a group of students)

Forums (e.g., enable asynchronous discussions among various members of an institution. These Forums help students, educators and administrators post various topics, including items like assignments, online tutoring schedules, school events or teacher announcements),

Online Calendar/Organizer (e.g., available for all member communities (students, educators and administrators), the Organizer can help manage appointments and schedule any meetings. The reminder option when chosen may remind the user of the appointments),

The system may jumpstart the development of courseware by using a revolutionary system of e-learning content assimilation and deployment. It can feature an intuitive user interface, rapid course generation, powerful templates and automatic generation of navigation elements, chapter, and course indexes. The finished courses can easily be deployed to students.

Additionally, the system may reduce curriculum development time by more than 60% and dramatically slashes production costs.

Techniques described herein may also provide for an easy to use visual content editor that requires no programming knowledge.

Techniques may also provide the ability to upload rich media, including images, video and audio.

Assignments: The Assignment Editor may be integrated into a full-fledged HTML Editor that allows users to create engaging content for the assignments.

Assessments: The Assessment Editor may be integrated to a powerful Question Editor which supports most types of questions:

Multiple Choice Single Answers

Multiple Choice Multiple Answers

Yes or No

Fill In the Blanks

Ordering

Matching

Short essays

Indeed, items created with the Question Editor can be used to create assessments, which may then be easily imported to the system.

Thus, students may use the system to engage in one-to-one learning with educators and also interact with other students in virtual classes. Useful communication tools may be provided, such as audio videochat, designed for live discussions between classmates and educators; forums to post a question or favorite topic to the class community in the form of a threaded discussion; and organizers to manage events and assessment details.

Educators may be engaged in one-to-one teaming with their students, allowing them to tailor instructions to compliment the learning style and needs of each individual student. Platform tools can allow ongoing monitoring of each student's performance. Educators can also create custom assessments with the help of the Question Editor, and build their own courses with the help of the Content Management System, using the built-in Editor or in conjunction with various other content authoring programs.

Additionally, school administrators can monitor the performance of students and educators in all classes. By using the techniques described herein, users can not only monitor student and teacher performance, but can also compare the performances of class-to-class and school-to-school. In addition, the system can enable institutions to be free from technology cycles, involve only access to the Internet and a PC, enable educators to customize content and build custom courses and assessments, and strengthen Internet-based educational offerings. Moreover, the system can allow educational institutions to improve students' skills in deficient areas, launch virtual learning environments quickly, conduct e-Tutoring & e-Conferencing, ensure that various standards are being tested and met, reduce burden on educators, enable educators to build their own courses and assessments, and provides an open architecture and flexibility for new educational applications.

Techniques described herein can therefore aid in assessing and also improve student performance by helping educators integrate technology and the curriculum. These solutions may deliver complete world class e-learning capabilities with integrated, state of the art tools, resulting in a new standard of e-learning. For example, embodiments of the present invention can provide standardization to the structure of classroom based collaborative learning activities in order to enable sharing and reuse of collaborative pedagogical strategies implemented via the Internet.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A method, implemented at least partly in hardware, comprising:
receiving registration input for a student associated with a first facility, wherein the registration input includes a K-12 grade level identifier;
register the student in an online course associated with a second facility based on the registration input, wherein the online course is a classroomless course;
measuring an online presence of the student with respect to one or more of the course and a set of login sessions; and
generating a report based on the online presence, wherein the report quantifies one or more of a course material usage, an assessment usage, an assignment usage, an e-classroom usage, and a chat usage by the student.

2. The method of claim 1, further including:
receiving course creation input via a web-based interface;
generating the online course based on the course creation input; and
generating one or more of an assessment or an assignment for the online course based on the course creation input.

3. The method of claim 2, further including determining whether to hide the online course from one or more users based on the course creation input.

4. The method of claim 1, further including incorporating a live board into the online course.

5. A computer readable storage medium comprising a set of instructions which, if executed by a processor, cause a computer to:
receive registration input for a student associated with a first facility; and
register the student in an online course associated with a second facility based on the registration input.

6. The medium of claim 5, wherein the registration input is to include a K-12 grade level identifier.

7. The medium of claim 6, wherein the online course is to be a classroomless course.

8. The medium of claim 4, wherein the instructions, if executed, cause a computer to:
measure an online presence of the student; and
generate a report based on the online presence.

9. The medium of claim 8, wherein the online presence is to be measured with respect to the course.

10. The medium of claim 8, wherein the online presence is to be measured with respect to a set of login sessions.

11. The medium of claim 8, wherein the report is to quantify one or more of a course material usage, an assessment usage, an assignment usage, an e-classroom usage, and a chat usage by the student.

12. The medium of claim 5, wherein the instructions, if executed, cause a computer to:
receive course creation input via a web-based interface;
generate the online course based on the course creation input;
generate one or more of an assessment or an assignment for the online course based on the course creation input;
determine whether to hide the online course from one or more users based on the course creation input; and
incorporate a live board into the online course.

13. An apparatus comprising:
an administration logic module to receive registration input for a student associated with a first facility; and
a core logic module to register the student in an online course associated with a second facility based on the registration input.

14. The apparatus of claim 13, wherein the registration input is to include a K-12 grade level identifier.

15. The apparatus of claim 14, wherein the online course is to be a classroomless course.

16. The apparatus of claim 13, wherein the administration logic module is to measure an online presence of the student and generate a report based on the online presence.

17. The apparatus of claim 16, wherein the online presence is to be measured with respect to the course.

18. The apparatus of claim 16, wherein the online presence is to be measured with respect to a set of login sessions.

19. The apparatus of claim 16, wherein the report is to quantify one or more of a course material usage, an assessment usage, an assignment usage, an e-classroom usage and a chat usage by the student.

20. The apparatus of claim 13, wherein the administration logic module is to receive course creation input via a web-based interface, and wherein the core logic module is to generate the online course based on the course creation input, generate one or more of an assessment or an assignment for the online course based on the course creation input, determine whether to hide the online course from one or more users based on the course creation input, and incorporate a live bard into the online course.
